(19) United States
(12) Patent Application Publication
(10) Pub. No.: US 2024/0240594 A1
(43) Pub. Date: Jul. 18, 2024

(54) FUEL SUPPLY SYSTEM AND FUEL SUPPLY METHOD FOR GAS TURBINE COGENERATION SYSTEM

(71) Applicant: MITSUBISHI HEAVY INDUSTRIES, LTD., Tokyo (JP)

(72) Inventors: Takashi Asao, Tokyo (JP); Kazuhiko Sato, Tokyo (JP); Shohei Yoshida, Tokyo (JP); Ryo Akiyama, Tokyo (JP)

(73) Assignee: MITSUBISHI HEAVY INDUSTRIES, LTD., Tokyo (JP)

(21) Appl. No.: 18/512,587

(22) Filed: Nov. 17, 2023

(30) Foreign Application Priority Data
Jan. 18, 2023 (JP) 2023-005769

(51) Int. Cl. F02C 9/40; F02C 3/24; F02C 7/22

(52) U.S. Cl. CPC F02C 9/40; F02C 3/24; F02C 7/222

(57) ABSTRACT

A fuel supply system includes: a fuel gas supply line configured to supply a fuel gas to a combustor of a gas turbine; a first off-gas supply device configured to supply a first off-gas generated in a fuel refining plant to the combustor; a second off-gas supply device configured to supply a second off-gas generated in a bio-liquid fuel production plant to the combustor, the second off-gas having a calorific value per unit mass smaller than the fuel gas; a gas mixing device configured to mix the fuel gas supplied by the fuel gas supply line, the first off-gas supplied by the first off-gas supply device, and the second off-gas supplied by the second off-gas supply device; and a mixed gas fuel supply line configured to supply a mixed gas fuel produced by the gas mixing device to the combustor.

### CROSS-REFERENCE TO RELATED APPLICATIONS

This application claims the benefit of priority to Japanese Patent Application Number 2023-005769 filed on Jan. 18, 2023. The entire contents of the above-identified application are hereby incorporated by reference.

### TECHNICAL FIELD

The disclosure relates to a fuel supply system for a gas turbine cogeneration system using at least off-gas as a fuel and a fuel supply method for the gas turbine cogeneration system.

### RELATED ART

A gas turbine cogeneration system disclosed in JP 2008-163873 A incorporates a liquid fuel synthesis reaction vessel configured to produce a liquid fuel from a gasified gas obtained from a solid fuel including coal. The gas turbine of this document is driven by using an off-gas generated in the liquid fuel synthesis reaction vessel as a fuel.

### SUMMARY

To achieve a carbon-neutral society, a solid fuel is preferably biomass. However, when biomass is adopted as a solid fuel, the calorific value per unit mass of the off-gas obtained from the liquid fuel synthesis reaction vessel is generally small, and it is difficult to drive an existing gas turbine using the off-gas as a sole fuel.

An object of the disclosure relates to a fuel supply system that drives a gas turbine cogeneration system using, as a fuel, an off-gas generated in the course of producing a bio-liquid fuel from biomass, and a fuel supply method for the gas turbine cogeneration system.

A fuel supply system according to at least one embodiment of the disclosure includes: a fuel gas supply line configured to supply a fuel gas to a combustor of a gas turbine; a first off-gas supply device configured to supply a first off-gas generated in a fuel refining plant to the combustor; a second off-gas supply device configured to supply a second off-gas generated in a bio-liquid fuel production plant to the combustor, the second off-gas having a calorific value per unit mass smaller than the fuel gas; a gas mixing device configured to mix the fuel gas supplied by the fuel gas supply line, the first off-gas supplied by the first off-gas supply device, and the second off-gas supplied by the second off-gas supply device; and a mixed gas fuel supply line configured to supply a mixed gas fuel produced by the gas mixing device to the combustor.

A fuel supply method for a gas turbine cogeneration system according to an embodiment of the disclosure is a fuel supply method for a gas turbine cogeneration system for supplying a fuel to a gas turbine cogeneration system.

The gas turbine cogeneration system includes:
a gas turbine including a combustor; and
a waste heat recovery boiler for producing steam using an exhaust gas discharged from the gas turbine as a heat source.

The method includes:
a start-up fuel supply step of supplying exclusively a fuel gas as a start-up fuel for the gas turbine; and
a mixed gas fuel supply step of supplying a mixed gas fuel to the combustor after execution of the start-up fuel supply step, the mixed gas fuel containing the fuel gas, a first off-gas generated in a fuel refining plant, and a second off-gas generated in a bio-liquid fuel production plant, the second off-gas having a calorific value per unit mass smaller than the fuel gas.

According to the disclosure, it is possible to provide a fuel supply system that drives a gas turbine cogeneration system using, as a fuel, an off-gas generated in the course of producing a bio-liquid fuel from biomass, and a fuel supply method for the gas turbine cogeneration system.

### BRIEF DESCRIPTION OF DRAWINGS

The disclosure will be described with reference to the accompanying drawings, wherein like numbers reference like elements.

FIG. 1 is a schematic diagram of a plant according to an embodiment.

FIG. 2 is a schematic diagram of a fuel refining plant according to the embodiment.

FIG. 3 is a schematic diagram of a bio-liquid fuel production plant according to the embodiment.

FIG. 4 is a schematic diagram of a fuel supply system according to the embodiment.

FIG. 5 is a schematic diagram of a water recovery system according to the embodiment.

FIG. 6 is a schematic diagram illustrating supply lines of an oxygen gas and a hydrogen gas generated by an electrolysis device according to the embodiment.

FIG. 7 is a flowchart illustrating a start-up method of a plant according to a first embodiment.

FIG. 8 is a flowchart illustrating a continuation of the start-up method of the plant.

FIG. 9 is a schematic diagram illustrating a process of the start-up method of the plant according to the embodiment.

FIG. 10 is a schematic diagram illustrating a process of the start-up method of the plant according to the embodiment.

FIG. 11 is a schematic diagram illustrating a process of the start-up method of the plant according to the embodiment.

FIG. 12 is a schematic diagram illustrating a process of the start-up method of the plant according to the embodiment.

FIG. 13 is a schematic diagram illustrating a process of the start-up method of the plant according to the embodiment.

FIG. 14 is a schematic diagram illustrating a process of the start-up method of the plant according to the embodiment.

FIG. 15 is a schematic diagram illustrating a process of the start-up method of the plant according to the embodiment.

FIG. 16 is a flowchart illustrating a start-up method of a plant according to a second embodiment.

FIG. 17 is a schematic diagram illustrating a process of the start-up method of the plant according to the embodiment.

FIG. 18 is a flowchart illustrating a modification method of the plant according to the embodiment.

FIG. 19 is a schematic diagram of the plant before modification according to the embodiment.

FIG. 20 is a schematic diagram of the plant during the modification according to the embodiment.

FIG. 21 is a schematic diagram of the plant after the modification according to the embodiment.

### DESCRIPTION OF EMBODIMENTS

Some embodiments of the disclosure will be described below with reference to the accompanying drawings. However, the dimensions, materials, shapes, relative dispositions, or the like of components described in the embodiments or illustrated in the drawings are not intended to limit the scope of the disclosure and are merely illustrative examples.

For example, expressions indicating relative or absolute arrangement such as “in a direction”, “along a direction”, “parallel”, “orthogonal”, “center”, “concentric”, or “coaxial” shall not be construed as indicating only such arrangement in a strict literal sense but also as indicating a state of being relatively displaced within a tolerance, or by an angle or a distance to the extent that the same function can be obtained.

For example, expressions indicating a state of being equal such as “same,” “equal,” or “uniform” shall not be construed as indicating only a state of being strictly equal, but also as indicating a state where there is a tolerance or a difference to the extent that the same function can be achieved.

For example, expressions indicating a shape such as a rectangular shape or a tube shape shall not be construed as only indicating a shape such as a rectangular shape or a tube shape in a strict geometrical sense but also as indicating a shape including depressions, protrusions, and chamfered corners to the extent that the same effect can be obtained.

In addition, expressions such as “comprising,” “including,” or “having” one component are not intended as exclusive expressions that exclude the presence of other components.

Note that the same reference signs may be assigned to similar components and the descriptions thereof may be omitted.

### 1. Outline of Plant 1

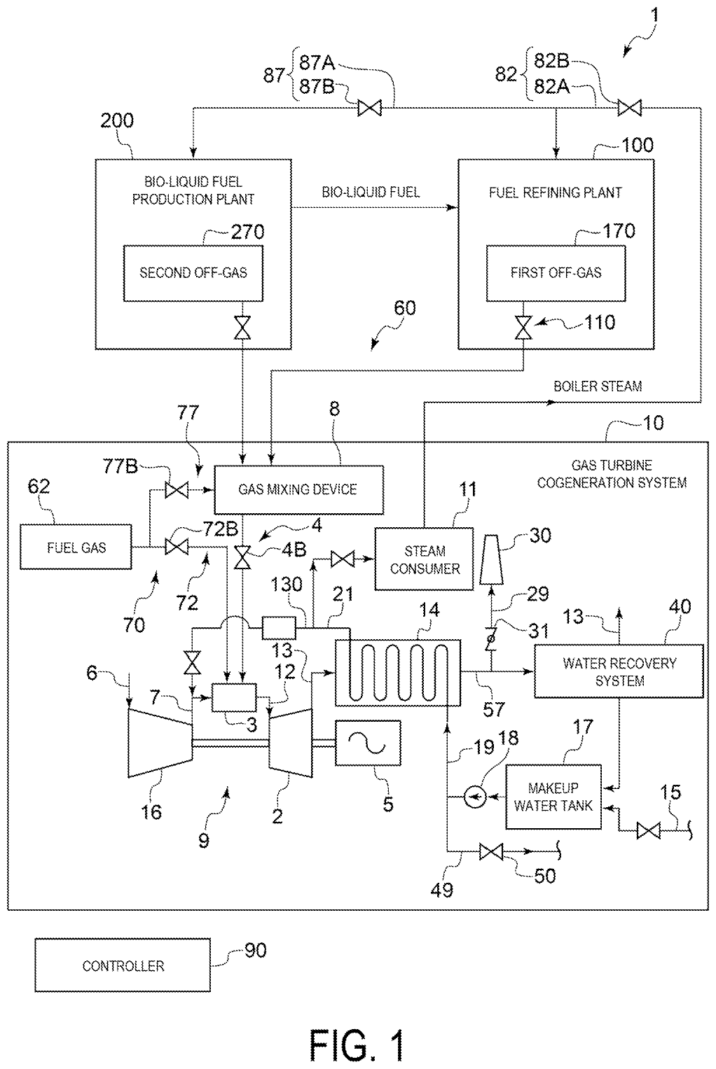

FIG. 1 is a schematic diagram of a plant 1 according to an embodiment of the disclosure. The plant 1 includes a gas turbine cogeneration system 10 including a gas turbine 9 and a waste heat recovery boiler 14, a fuel refining plant 100 for refining oil into a fuel, and a bio-liquid fuel production plant 200 for producing a bio-liquid fuel from biomass.

The gas turbine 9 performs a power generation function in the cogeneration system 10. The waste heat recovery boiler 14 is configured to produce steam using an exhaust gas 13 discharged from the gas turbine 9 as a heat source. At least part of a boiler steam which is a steam discharged from the waste heat recovery boiler 14 is supplied to the fuel refining plant 100 and the bio-liquid fuel production plant 200. As a more specific example, the boiler steam having passed through a steam consumer 11 disposed downstream of the waste heat recovery boiler 14 is supplied to both the plants. The boiler steam is used as a heat source for refining a fuel in the fuel refining plant 100, and is used as a gasification agent for obtaining a biomass gas from biomass in the bio-liquid fuel production plant 200.

As a component for supplying the boiler steam to both the plants, a boiler steam supply line 82 and a gasification agent steam supply line 87 are provided. The boiler steam supply line 82 includes a boiler steam supply pipe 82A connected to the steam consumer 11 and the fuel refining plant 100, and a boiler steam on-off valve 82B provided at the boiler steam supply pipe 82A. The gasification agent steam supply line 87 includes a gasification agent steam supply pipe 87A connected to the boiler steam supply pipe 82A and the bio-liquid fuel production plant 200, and a gasification agent steam on-off valve 87B provided at the gasification agent steam supply pipe 87A. The gasification agent steam supply pipe 87A is connected to the boiler steam supply pipe 82A at a position between the steam consumer 11 and the fuel refining plant 100, and the boiler steam extracted from the boiler steam supply pipe 82A flows through the gasification agent steam supply pipe 87A as a gasification agent.

A fuel supplied to the combustor 3 of the gas turbine 9 contains at least one of a fuel gas, a first off-gas generated in the fuel refining plant 100, or a second off-gas generated in the bio-liquid fuel production plant 200. The fuel gas has a relatively high calorific value per unit mass and is exclusively supplied to the combustor 3 for a start-up operation of the gas turbine 9. After completion of the start-up operation, the fuel gas is mixed with at least one of the first off-gas or the second off-gas and supplied to the combustor 3. In the present embodiment, mixing of gases is performed in a gas mixing device 8 constituting the gas turbine cogeneration system 10.

The fuel gas contains, for example, at least one of LNG or LPG. The fuel gas in the present example is LPG (liquefied petroleum gas). In this case, the LPG is refined as a fuel gas in the fuel refining plant 100. The calorific value per unit mass of the second off-gas is lower than that of the fuel gas. Further, in the present example, the calorific value per unit mass of the second off-gas is lower than that of the first off-gas. Specific examples of the first off-gas and the second off-gas will be described below.

Configurations of the fuel refining plant 100, the bio-liquid fuel production plant 200, a fuel supply system 60 for supplying a fuel for the gas turbine, and the gas turbine cogeneration system 10 will be described below in this order. In the following description, the gas turbine cogeneration system 10 may be abbreviated as a “cogeneration system 10”.

### 2. Fuel Refining Plant 100

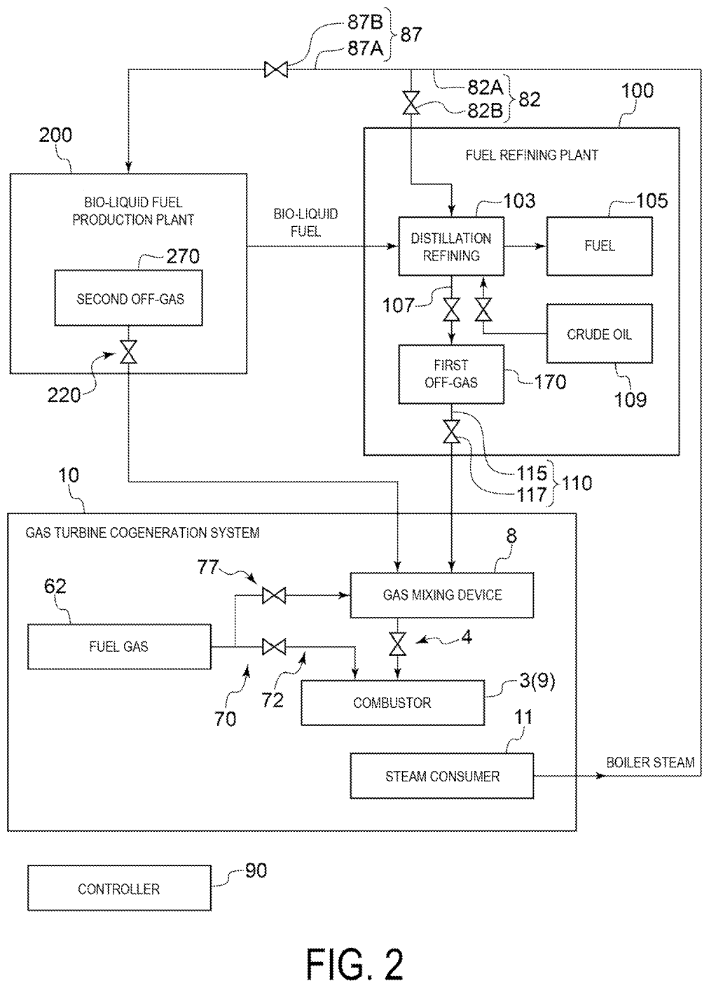

FIG. 2 is a schematic diagram of the fuel refining plant 100 according to an embodiment of the disclosure. The fuel refining plant 100 includes a distillation refining device 103 and a fuel storage facility 105. The distillation refining device 103 is configured to refine oil into a fuel using the boiler steam supplied by the boiler steam supply pipe 82A as a heat source. The oil may be crude oil or coarse oil of bio-liquid fuel. In the present embodiment, a crude oil supplied from a crude oil supply facility 109 or a bio-liquid fuel (coarse oil) supplied from the bio-liquid fuel production plant 200 is selectively supplied to the distillation refining device 103. The fuel as a product to be refined is, for example, bio-jet fuel, naphtha, or LPG. The refined fuel may be used as a fuel for the combustor 3 or may be used as a fuel for other equipment.

Although not illustrated in detail, the distillation refining device 103 includes a heating furnace for heating the oil and a distillation tower for distilling the oil discharged from the heating furnace to extract a fuel. The boiler steam supply pipe 82A of the present example is connected to the distillation tower, and the distillation tower distills the oil using the boiler steam as a heat source. The fuel refined through distillation is supplied to the fuel storage facility 105.

The fuel refining plant 100 further includes a first off-gas discharge tube 107 through which the first off-gas generated by the distillation tower of the distillation refining device 103 flows, a first off-gas supply device 170 configured to receive the first off-gas flowing through the first off-gas discharge tube 107, and a first off-gas supply line 110 for supplying the first off-gas from the first off-gas supply device 170 to the gas mixing device 8.

The first off-gas supply device 170 is configured to increase the pressure of the first off-gas and cause the first off-gas to flow through the first off-gas supply line 110. The first off-gas supply line 110 includes a first off-gas supply pipe 115 connected to the first off-gas supply device 170 and the gas mixing device 8, and a first off-gas on-off valve 117 provided at the first off-gas supply pipe 115. The first off-gas supply pipe 115 guides the first off-gas discharged from the first off-gas supply device 170 to the gas mixing device 8. A gas containing the first off-gas produced by mixing in the gas mixing device 8 is supplied to the combustor 3 of the gas turbine 9 (details will be described below). Thus, both the first off-gas supply device 170 and the first off-gas supply line 110 perform a function to supply the first off-gas to the combustor 3. The first off-gas contains, for example, at least one of methane gas, ethane gas, butane gas, or propane gas.

### 3. Bio-Liquid Fuel Production Plant 200

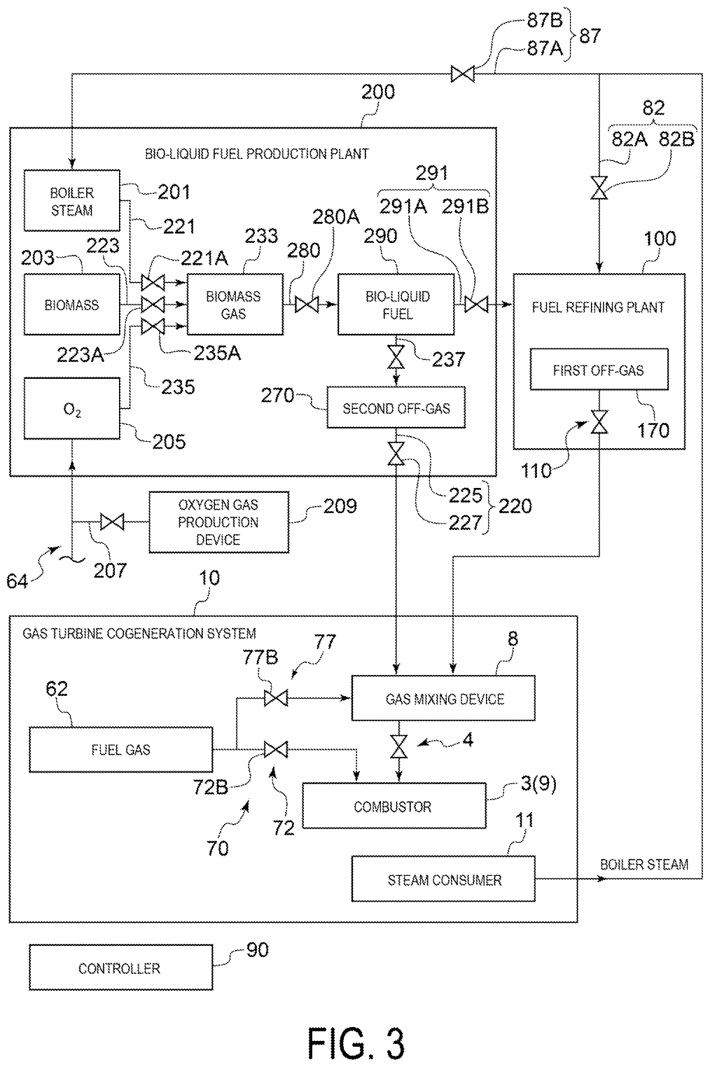

FIG. 3 is a schematic diagram of the bio-liquid fuel production plant 200 according to an embodiment of the disclosure. The bio-liquid fuel production plant 200 includes a steam supply device 201 configured to receive the boiler steam supplied by the gasification agent steam supply pipe 87A, a biomass supply device 203 that is a supply source of biomass, an oxygen gas supply device 205 for supplying oxygen-gas, and a gasification device 233 for producing a biomass gas from the biomass.

The steam supply device 201 supplies a steam as a gasification agent to the gasification device 233 via a steam supply tube 221. The steam supplied by the steam supply device 201 contains the boiler steam supplied by the gasification agent steam supply line 87. The biomass supply device 203 performs a drying treatment and a grinding process on the biomass which may be, for example, wood biomass. The biomass discharged from the biomass supply device 203 is supplied to the gasification device 233 via a biomass supply tube 223. The oxygen gas discharged from the oxygen gas supply device 205 is supplied to the gasification device 233 via an oxygen gas supply tube 235. The steam supply tube 221, the biomass supply tube 223, and the oxygen gas supply tube 235 are provided with a steam on-off valve 221A, a biomass on-off valve 223A, and an oxygen gas on-off valve 235A, respectively.

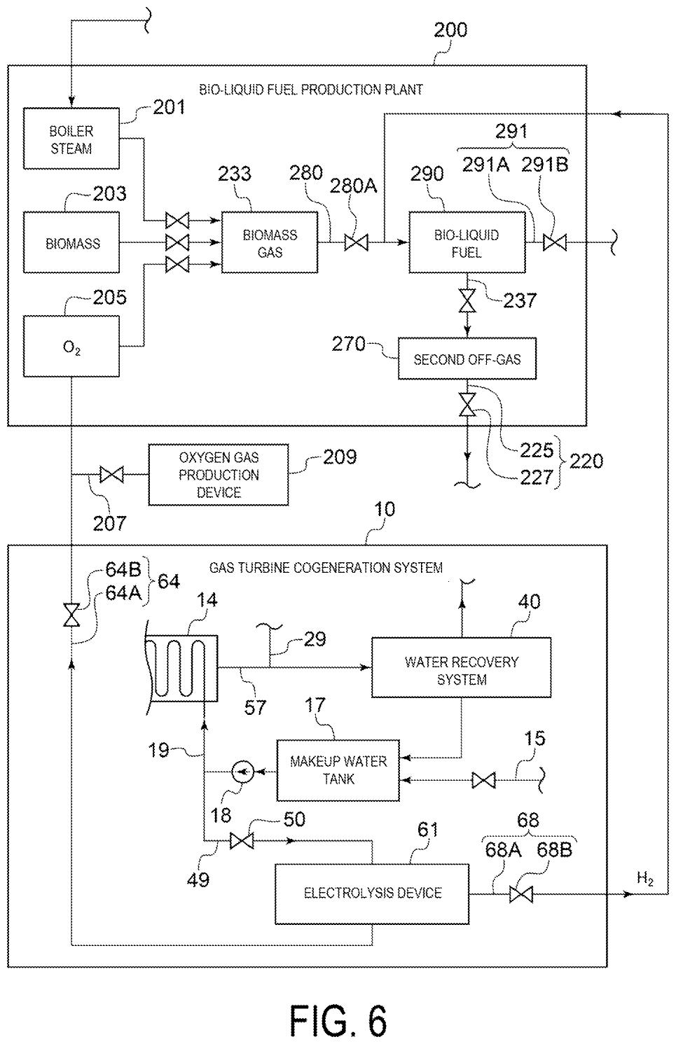

The oxygen gas flowing into the oxygen gas supply device 205 of the present embodiment contains an oxygen gas produced by an oxygen gas production device 209 and an oxygen gas produced by an electrolysis device 61 (see FIG. 6). The oxygen gas production device 209 is configured to extract the oxygen gas from the atmosphere by pressure swing adsorption (PSA). Although the details of the electrolysis device 61 will be described below, the oxygen gas produced by the electrolysis device 61 is supplied to the oxygen gas supply device 205 through an oxygen gas supply line 64.

The gasification device 233 is configured to produce a biomass gas from the biomass by using the boiler steam and the oxygen gas as gasification agents. More specifically, the gasification device 233 includes a gas furnace that employs an entrained-flow biomass gasification process. The boiler steam and the oxygen gas flow into the gas furnace at the vicinity of the bottom of the gas furnace, and the biomass flows into the gas furnace above the bottom. The boiler steam and the oxygen gas mixed in the gas furnace are raised and blown against the biomass to produce a biomass gas. The biomass gas contains at least one of hydrogen, carbon monoxide, or carbon dioxide.

As illustrated in FIG. 3, the bio-liquid fuel production plant 200 further includes a biomass gas discharge tube 280 through which the biomass gas discharged from the gasification device 233 flows, a biomass gas on-off valve 280A provided at the biomass gas discharge tube 280, and a bio-liquid fuel production device 290 configured to produce a bio-liquid fuel from the biomass gas flowing in through the biomass gas discharge tube 280. The bio-liquid fuel production device 290 of the present embodiment employs the Fischer-Tropsch process. More specifically, bio-liquid fuel production device 290 is configured to produce a bio-liquid fuel from a biomass gas by using iron and cobalt as catalysts. The bio-liquid fuel of the present example is a coarse oil which is a feedstock of a bio-jet fuel.

The bio-liquid fuel production plant 200 according to some embodiments further includes a bio-liquid fuel supply line 291 for supplying the bio-liquid fuel discharged from the bio-liquid fuel production device 290 to the fuel refining plant 100 as an oil (coarse oil) to be refined. The bio-liquid fuel supply line 291 includes a bio-liquid fuel supply pipe 291A connected to the bio-liquid fuel production device 290 and the heating furnace of the distillation refining device 103 (see FIG. 2), and a bio-liquid fuel on-off valve 291B provided at the bio-liquid fuel supply pipe 291A.

In the bio-liquid fuel production device 290 described above, the second off-gas is generated together with the bio-liquid fuel. The bio-liquid fuel production plant 200 of the present example further includes a second off-gas discharge tube 237 through which the second off-gas generated in the bio-liquid fuel production device 290 flows, a second off-gas supply device 270 that receives the second off-gas flowing through the second off-gas discharge tube 237, and a second off-gas supply line 220 for supplying the second off-gas from the second off-gas supply device 270 to the gas mixing device 8.

The second off-gas supply device 270 is configured to increase the pressure of the second off-gas and discharge the second off-gas to the second off-gas supply line 220. The second off-gas supply line 220 includes a second off-gas supply pipe 225 connected to the second off-gas supply device 270 and the gas mixing device 8, and a second off-gas on-off valve 227 provided at the second off-gas supply pipe 225. The second off-gas supply pipe 225 guides the second off-gas discharged from the second off-gas supply device 270 to the gas mixing device 8. A gas containing the second off-gas produced by mixing in the gas mixing device 8 is supplied to the combustor 3 of the gas turbine 9 (details will be described below). Thus, both the second off-gas supply device 270 and the second off-gas supply line 220 perform a function to supply the second off-gas to the combustor 3. The second off-gas contains, for example, at least one of methane gas, carbon monoxide, carbon dioxide, hydrogen gas, or nitrogen gas.

### 4. Fuel Supply System 60

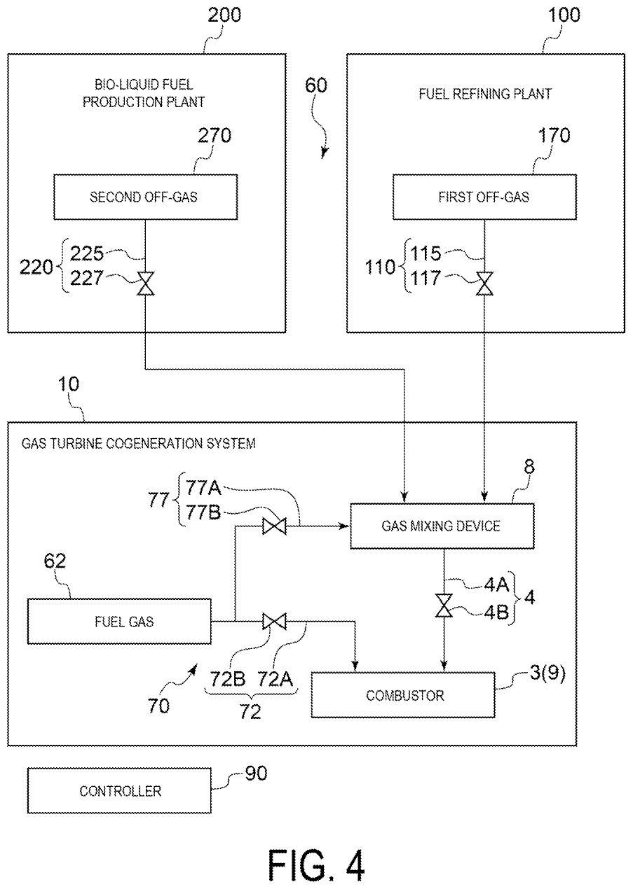

FIG. 4 is a schematic diagram of the fuel supply system 60 according to an embodiment of the disclosure. The fuel supply system 60 is configured to supply a fuel to the combustor 3 of the gas turbine 9. Components of the fuel supply system 60 are also components of any of the fuel refining plant 100, the bio-liquid fuel production plant 200, or the cogeneration system 10.

The fuel supply system 60 according to the embodiment of the disclosure includes the first off-gas supply device 170, the first off-gas supply line 110, the second off-gas supply device 270, and the second off-gas supply line 220. The details of these components are as described above. The fuel supply system 60 further includes a fuel gas supply source 62, a fuel gas supply line 70 for supplying the fuel gas from the fuel gas supply source 62 to the combustor 3, the gas mixing device 8 for mixing the fuel gas, the first off-gas, and the second off-gas, and a mixed gas fuel supply line 4 for supplying the mixed gas fuel produced by the gas mixing device 8 to the combustor 3.

The fuel gas supply source 62 of the present example is a tank storing the fuel gas, and is installed at the plant 1. In another example, the fuel gas supply source 62 may be a large tank lorry that is anchored near the plant 1. In that case, the fuel gas supply source 62 is not necessarily a component of the fuel supply system 60.

The fuel gas supply line 70 includes a start-up fuel gas supply line 72 for supplying the fuel gas as a start-up fuel to the combustor 3, and a mixing fuel gas supply line 77 provided in parallel with the start-up fuel gas supply line 72 configured to supply the fuel gas to the gas mixing device 8. The start-up fuel gas supply line 72 includes a start-up fuel gas supply pipe 72A connected to the fuel gas supply source 62 and the combustor 3, and a start-up fuel gas on-off valve 72B provided at the start-up fuel gas supply pipe 72A. The mixing fuel gas supply line 77 includes a mixing fuel gas supply pipe 77A connected to the start-up fuel gas supply pipe 72A and the gas mixing device 8, and a mixing fuel gas on-off valve 77B provided at the mixing fuel gas supply pipe 77A. The mixing fuel gas supply pipe 77A is connected to the start-up fuel gas supply pipe 72A at a position between the fuel gas source 62 and the start-up fuel gas on-off valve 72B. The mixed gas fuel supply line 4 includes a mixed gas fuel supply pipe 4A connected to the gas mixing device 8 and the combustor 3, and a mixed gas fuel on-off valve 4B provided at the mixed gas fuel supply pipe 4A.

The outline of the operation of the fuel supply system 60 for supplying a fuel is as follows.

At the start-up of the cogeneration system 10, the fuel gas from the fuel gas supply source 62 is exclusively supplied to the combustor 3. More specifically, along with the start-up of the cogeneration system 10, the start-up fuel gas on-off valve 72B is opened, and all of the mixing fuel gas on-off valve 77B, the first off-gas on-off valve 117, the second off-gas on-off valve 227, and the mixed gas fuel on-off valve 4B are closed. Accordingly, the fuel gas is supplied exclusively to the combustor 3 by the start-up fuel gas supply line 72.

After the start-up of the cogeneration system 10, the start-up fuel gas on-off valve 72B is closed. Around this closing timing, all of the mixing fuel gas on-off valve 77B, the first off-gas on-off valve 117, the second off-gas on-off valve 227, and the mixed gas fuel on-off valve 4B are opened. The gas mixing device 8 produces a mixed gas fuel by mixing the fuel gas, the first off-gas, and the second off-gas. The mixed gas fuel containing the fuel gas, the first off-gas, and the second off-gas is supplied to the combustor 3 via the mixed gas fuel supply line 4.

According to the above-described configuration, the second off-gas generated in the course of producing the bio-liquid fuel from the biomass can be used as a fuel of the combustor 3 together with the fuel gas and the first off-gas. Accordingly, the calorific value obtained by combustion in the combustor 3 can be secured and the temperature of a combustion gas 12 (see FIG. 1) which is to be supplied to a turbine 2 as will be described below can be increased so that the gas turbine 9 can be driven. Thus, the cogeneration system 10 that is driven using the second off-gas obtained in the course of producing the bio-liquid fuel from the biomass as a fuel is implemented. In addition, since the second off-gas is used as a fuel, it is possible to reduce the consumption amount of the fuel gas having a large calorific value per unit mass and to contribute to carbon neutrality.

The bio-liquid fuel produced by the bio-liquid fuel production plant 200 is not necessarily supplied to the fuel refining plant 100. That is, the bio-liquid fuel production plant 200 does not necessarily include the bio-liquid fuel supply line 291. Even in this case, the above-described advantages can be achieved.

Further, the gas mixing device 8 may execute an operation of discharging a first mixed gas fuel containing the fuel gas and the first off-gas or an operation of discharging a second mixed gas fuel containing the fuel gas and the second off-gas before the operation of discharging the mixed gas fuel described above. The details will be described below together with a start-up method of the cogeneration system 10.

According to the configuration in which the gas mixing device 8 and the mixed gas fuel supply line 4 are provided, the mixed gas fuel produced by mixing the fuel gas, the first off-gas, and the second off-gas is supplied to the combustor 3. Thus, the influence of the relatively small calorific value of the second off-gas can be reduced, and the shortage of the calorific value obtained in the combustor 3 can be avoided. In addition, the second off-gas can be used as a fuel even in the existing combustor 3 in which it is difficult to increase the temperature of an exhaust gas 13 (see FIG. 1) to be described below by supplying the second off-gas alone, which can contribute to carbon neutrality.

According to the fuel supply system 60 described above, the mixed gas fuel supply line 4 can use the second off-gas generated in the bio-liquid fuel production plant 200 as a fuel for the combustor 3 together with the fuel gas and the first off-gas. Accordingly, the calorific value obtained by combustion in the combustor 3 can be secured and the temperature of the combustion gas 12 (see FIG. 1) which is to be supplied to the turbine 2 as will be described below can be increased so that the gas turbine 9 can be driven. As a result, the fuel supply system 60 to drive the gas turbine 9 using the second off-gas obtained in the course of producing the bio-liquid fuel from the biomass as a fuel is implemented.

To implement the fuel supply system 60 described above, it is not necessary to supply the boiler steam to each of the fuel refining plant 100 and the bio-liquid fuel production plant 200. In addition, the bio-liquid fuel produced by the bio-liquid fuel production plant 200 is not necessarily supplied to the fuel refining plant 100. That is, the bio-liquid fuel production plant 200 does not necessarily include the bio-liquid fuel supply line 291. Even in this case, the above-described advantages can be achieved.

According to the configuration in which the mixing fuel gas supply line 77 is provided in parallel with the start-up fuel gas supply line 72, the start-up fuel gas supply line 72 and the mixed gas fuel supply line 4 can use the fuel gas supply source 62 in common, and thus the configuration of the fuel supply system 60 can be simplified.

According to the configuration in which the bio-liquid fuel production plant 200 includes the bio-liquid fuel supply line 291 for supplying the bio-liquid fuel to the fuel refining plant 100, it is possible to refine the bio-liquid fuel into a fuel such as a bio-jet fuel.

### 5. Gas Turbine Cogeneration System 10

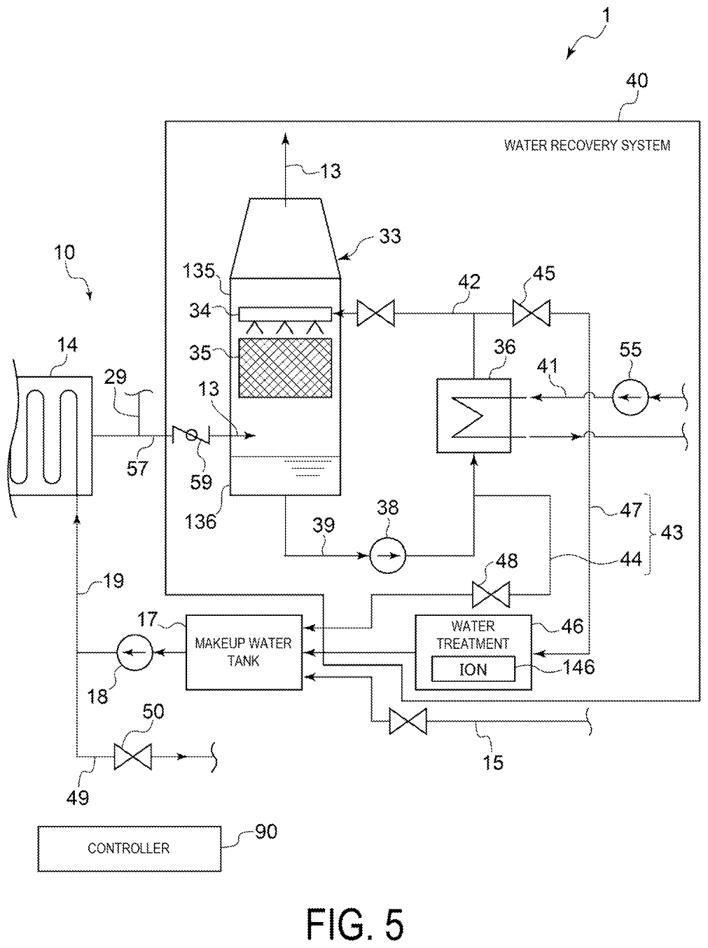

The gas turbine cogeneration system 10 will be described with reference to FIGS. 1 and 5. FIG. 5 is a schematic diagram of a water recovery system 40 according to an embodiment.

### 5-1. Outline of Cogeneration System 10

The cogeneration system 10 illustrated in FIG. 1 includes the gas turbine 9 and the waste heat recovery boiler 14. The gas turbine 9 includes a compressor 16 for producing a compressed air 7 from a compressor inlet air 6, the combustor 3 for producing the combustion gas 12 by combusting a fuel supplied by the fuel supply system 60 and increasing the temperature of the compressed air 7, the turbine 2 rotated using the combustion gas 12 discharged from the combustor 3 as a drive source, and a generator 5 coupled to the turbine 2. The combustor 3 of the present embodiment is a diffusion type combustor. The fuel to be combusted by the combustor 3 is supplied by the fuel supply system 60 described above.

The waste heat recovery boiler 14 is configured to produce steam from boiler feedwater using the exhaust gas 13, which is the combustion gas 12 discharged from the turbine 2, as a heat source. Here, the boiler feedwater is water supplied to the waste heat recovery boiler 14. The cogeneration system 10 includes a steam supply pipe 21 for supplying the boiler steam discharged from the waste heat recovery boiler 14 to the steam consumer 11. The steam consumer 11 of the present example is a steam turbine. The steam consumer 11 according to another example may be a steam turbine of a combined power plant, an industrial process device, or the like.

Although not an essential component of the disclosure, the cogeneration system 10 includes a steam extraction pipe 130 for supplying the boiler steam extracted from the steam supply pipe 21 to the combustor 3. The steam extraction pipe 130 illustrated in the drawing is configured to supply the boiler steam to a head end (not illustrated) side of the combustor 3. The boiler steam supplied to the head end side reduces the temperature of a flame zone of the combustor 3, thereby suppressing the generation of nitrogen oxide in the combustor 3.

Although not essential components of the disclosure, the cogeneration system 10 includes a water recovery system 40 for recovering moisture contained in the exhaust gas 13 discharged from the waste heat recovery boiler 14, a makeup water tank 17 that stores a recovered water containing the moisture recovered from the water recovery system 40 as the boiler feedwater, a water supply line 15 for supplying a makeup water to the makeup water tank 17, a water supply line 19 connected to the makeup water tank 17 and the waste heat recovery boiler 14, and a water supply pump 18 provided at the water supply line 19. The configuration of the water recovery system 40 will be described in detail below. When the water supply pump 18 is driven, the boiler feedwater stored in the makeup water tank 17 flows through the water supply line 19 and is supplied to the waste heat recovery boiler 14. The temperature of the boiler feedwater supplied to the waste heat recovery boiler 14 is preferably high. This is because the calorific value required for the waste heat recovery boiler 14 to produce steam is reduced and the efficiency of the cogeneration system 10 is improved.

Although not essential components of the disclosure, the cogeneration system 10 includes an exhaust gas supply line 57 that is a supply line of the exhaust gas 13 from the waste heat recovery boiler 14 to the water recovery system 40, an exhaust line 29 provided so as to branch from the exhaust gas supply line 57, and an exhaust damper 31 provided at the exhaust line 29. The exhaust gas 13 flowing through the exhaust line 29 is discharged to the outside from an exhaust tower 30. In an embodiment of the disclosure, when the exhaust gas 13 is supplied from the cogeneration system 10 to the water recovery system 40, the exhaust damper 31 is closed and thus the exhaust gas 13 does not flow through the exhaust line 29.

### 5-2. Water Recovery System 40

The outline of the water recovery system 40 illustrated in FIG. 5 is as follows. A water recovery device 33, which is a component of the water recovery system 40, is configured to recover moisture in the exhaust gas 13 as a recovered water by causing gas-liquid contact between the exhaust gas 13 guided by the exhaust gas supply line 57 and a refrigerant water. As a more detailed example, the water recovery device 33 includes a heat exchange vessel 135 into which the exhaust gas 13 and the refrigerant water flow, a water sprinkling device 34 for sprinkling the refrigerant water inside the heat exchange vessel 135, and a filler 35 located below the water sprinkling device 34 inside the heat exchange vessel 135. When a water recovery damper 59 provided at the exhaust gas supply line 57 is opened, the exhaust gas 13 flows into the heat exchange vessel 135 from the exhaust gas supply line 57. The refrigerant water sprinkled by the water sprinkling device 34 adheres to the filler 35 and exchanges heat with the exhaust gas 13 flowing into the heat exchange vessel 135. As a result, the moisture in the exhaust gas 13 is condensed. The recovered water containing the condensed moisture and the refrigerant water after the heat exchange drops and is stored in a water storage tank 136 constituting a lower portion of the heat exchange vessel 135.

The configuration of the water recovery system 40 will be described in detail. The water recovery system 40 further includes a recovered water cooling device 36 for cooling the recovered water discharged from the water storage tank 136 of the water recovery device 33, a recovered water discharge line 39 for guiding the recovered water discharged from the water storage tank 136 of the water recovery device 33 to the recovered water cooling device 36, and a recovered water supply line 42 for guiding the cooled recovered water discharged from the recovered water cooling device 36 to the heat exchange vessel 135 as a refrigerant water. The recovered water cooling device 36 of the present example is configured to cool the recovered water with cooling water that may be, for example, seawater. A cooling water supply line 41 for supplying the cooling water to the recovered water cooling device 36 is provided with a cooling water supply pump 55.

The water recovery system 40 further includes a water supply line 43 for guiding the recovered water to the makeup water tank 17, and the water supply line 43 includes a high-temperature water supply line 44 and a low-temperature water supply line 47. The high-temperature water supply line 44 is connected to the recovered water discharge line 39, and is configured to guide the recovered water taken out from the recovered water discharge line 39 to the makeup water tank 17. The recovered water taken out from the recovered water discharge line 39 has the heat recovered from the exhaust gas 13 and thus has a relatively high temperature. The low-temperature water supply line 47 is connected to the recovered water supply line 42, and is configured to guide the recovered water taken out from the recovered water supply line 42 to the makeup water tank 17. The recovered water taken out from the recovered water supply line 42 has been subjected to a cooling treatment by the recovered water cooling device 36 and thus has a relatively low temperature.

The low-temperature water supply line 47 is provided with a water treatment device 46 which is a component of the water recovery system 40. The water treatment device 46 is configured to perform a treatment for removing impurities such as sulfur from the recovered water flowing through the low-temperature water supply line 47. The impurities are generated along with the combustion in the combustor 3 (see FIG. 1) and may be mixed into the exhaust gas 13. At least part of the impurities is dissolved in the recovered water by the heat exchange between the exhaust gas 13 and the refrigerant water in the water recovery device 33. Since the water treatment device 46 removes the impurities contained in the recovered water, the impurities are prevented from being contained in the boiler feedwater stored in the makeup water tank 17. In general, the lower the temperature of water to be treated is, the higher the capacity of the treatment for removing the impurities in the water treatment device 46 becomes. When the temperature of the recovered water is high, an ion exchange resin 146 constituting the water treatment device 46 may be damaged and the capacity of the treatment for removing the impurities may be reduced.

The high-temperature water supply line 44 is provided with a high-temperature water supply on-off valve 48, and the low-temperature water supply line 47 is provided with a low-temperature water supply on-off valve 45. When the fuel gas which may be LPG classified as a clean energy is supplied to the combustor 3 as a start-up fuel for the cogeneration system 10, or when the second off-gas generated in the bio-liquid fuel production plant 200 is supplied to the combustor 3 together with the fuel gas after the start-up of the cogeneration system 10, the amount of the impurities mixed in the exhaust gas 13 is smaller than an allowable value. In this case, the high-temperature water supply on-off valve 48 is opened so that the recovered water having a high temperature that does not require the treatment for removing the impurities flows into the makeup water tank 17 via the high-temperature water supply line 44 (at this time, the low-temperature water supply on-off valve 45 is closed). Accordingly, the temperature of the boiler feedwater supplied from the makeup water tank 17 to the waste heat recovery boiler 14 can be increased, and thus the efficiency of the cogeneration system 10 is improved.

On the other hand, when the first off-gas generated in the fuel refining plant 100 is supplied to the combustor 3 together with the fuel gas after the start-up of the cogeneration system 10, the amount of the impurities mixed in the exhaust gas 13 is equal to or larger than the allowable value and smaller than an allowable upper limit value. In this case, the high-temperature water supply on-off valve 48 is closed and the low-temperature water supply on-off valve 45 is opened so that the recovered water having a low temperature that requires the treatment for removing the impurities flows into the makeup water tank 17 via the water treatment device 46 provided at the low-temperature water supply line 47. Thus, it is possible to prevent the impurities from adhering to equipment constituting the cogeneration system 10, such as the water supply line 19 and the waste heat recovery boiler 14, and to suppress the deterioration of the cogeneration system 10.

When the amount of the impurities contained in the exhaust gas 13 is equal to or larger than the allowable upper limit value, the water recovery damper 59 is closed and the exhaust damper 31 (see FIG. 1) is opened. As a result, the exhaust gas 13 is discharged from the exhaust tower 30 without being supplied to the water recovery system 40.

According to the above-described configuration, while the fuel gas as a start-up fuel is exclusively supplied to the combustor 3, or while the second off-gas is supplied to the combustor 3 together with the fuel gas, the amount of the impurities in the exhaust gas 13 flowing into the water recovery device 33 is smaller than the allowable value, and thus the recovered water can be supplied by the high-temperature water supply line 44. Therefore, the temperature of the boiler feedwater supplied to the waste heat recovery boiler 14 can be increased, and the operation efficiency of the cogeneration system 10 can be improved. On the other hand, while the mixed gas fuel containing the first off-gas is supplied to the combustor 3, the amount of the impurities in the exhaust gas 13 becomes equal to or larger than the allowable value and smaller than the allowable upper limit value. At this time, the low-temperature water supply line 47 supplies the recovered water instead of the high-temperature water supply line 44, and the water treatment device 46 can remove the impurities contained in the recovered water in the course of the supply of the recovered water. As a result, it is possible to prevent the equipment constituting the cogeneration system 10 from being corroded due to the adhesion of the impurities to the equipment. As described above, in the water recovery system 40 of the present embodiment, the water supply line 43 for the recovered water to be fed to the makeup water tank 17 can be switched in accordance with the amount of the impurities contained in the fuel to be supplied to the combustor 3.

### 5-3. Electrolysis Device 61

FIG. 6 is a schematic diagram illustrating supply lines of an oxygen gas and a hydrogen gas produced in the electrolysis device 61 according to an embodiment of the disclosure.

Although not essential components of the disclosure, the cogeneration system 10 may further include a water extraction line 49 for extracting the boiler feedwater flowing through the water supply line 19, a water extraction on-off valve 50 provided at the water extraction line 49, and the electrolysis device 61 connected to the water extraction line 49. The boiler feedwater extracted by the water extraction line 49 (hereinafter may be referred to as “industrial water”) contains the recovered water discharged from the water recovery device 33 (see FIG. 5) and the makeup water supplied by the water supply line 15.

The electrolysis device 61 is configured to perform an electrolysis treatment on the industrial water flowing through the water extraction line 49. By performing the electrolysis treatment, an oxygen gas and a hydrogen gas are produced from the industrial water. The oxygen gas produced by the electrolysis device 61 is supplied to the oxygen gas supply device 205 by the oxygen gas supply line 64 as a gasification agent for use in the gasification device 233 of the bio-liquid fuel production plant 200. The oxygen gas supply line 64, which is a component of the cogeneration system 10, includes an oxygen gas supply pipe 64A connected to the electrolysis device 61 and the oxygen gas supply device 205, and an oxygen gas on-off valve 64B provided at the oxygen gas supply pipe 64A. In the oxygen gas supply pipe 64A, the oxygen gas produced by the oxygen gas production device 209 described above is merged with the oxygen gas produced by the electrolysis device 61. More specifically, the oxygen gas production device 209 and the oxygen gas supply pipe 64A are connected by an oxygen gas discharge tube 207. The oxygen gas discharge tube 207 is connected to the oxygen gas supply pipe 64A at a position between the oxygen gas on-off valve 64B and the oxygen gas supply device 205.

The hydrogen gas produced by the electrolysis device 61 is supplied to the bio-liquid fuel production device 290 by a hydrogen gas supply line 68. The hydrogen gas supply line 68, which is a component of the cogeneration system 10, includes a hydrogen gas supply pipe 68A connected to the electrolysis device 61 and the biomass gas discharge tube 280, and a hydrogen gas on-off valve 68B provided at the hydrogen gas supply pipe 68A. The hydrogen gas flowing through the hydrogen gas supply pipe 68A is mixed with the biomass gas discharged from the gasification device 233 and supplied to the bio-liquid fuel production device 290.

According to the above-described configuration, the oxygen gas obtained by using the recovered water recovered by the water recovery device 33 can be used as a gasification agent for the gasification device 233. Thus, a sufficient amount of the gasification agent can be supplied to the gasification device 233 by utilizing the moisture contained in the exhaust gas 13. In addition, the hydrogen gas obtained by using the recovered water recovered by the water recovery device 33 can be used to produce a bio-liquid fuel. Thus, a sufficient amount of the hydrogen gas can be supplied to the bio-liquid fuel by utilizing the moisture contained in the exhaust gas 13. Further, in the above-described embodiment, the recovered water is utilized not only as a raw material of the bio-liquid fuel but also as a raw material of the second off-gas serving as a fuel for the combustor 3. Therefore, the moisture mixed in the exhaust gas 13 of the cogeneration system 10 can be utilized without waste.

### 6. Controller 90

The plant 1 further includes a controller 90 (see FIGS. 1 to 5). The controller 90 is configured by a computer, and includes a processor, a memory (storage medium), and an external communication interface. The processor is a CPU, a GPU, an MPU, a DSP, or a combination thereof. A processor according to another embodiment may be implemented by an integrated circuit such as a PLD, an ASIC, an FPGA, or an MCU. The memory is configured to store various types of data in a transitory or non-transitory manner, and is implemented by at least one of a RAM, a ROM, or a flash memory. The processor executes various control processes in accordance with instructions of programs loaded on the memory. Alternatively, the controller 90 may be a DCS board constituting one of a plurality of control boards of the plant 1.

The controller 90 transmits signals (control signals) to various types of equipment constituting the plant 1.

The various types of equipment constituting the plant 1 include an on-off valve. When the controller 90 transmits a signal (control signal) to the on-off valve, the on-off valve is switched between an open state and a closed state. Here, the on-off valve includes the mixed gas fuel on-off valve 4B, the low-temperature water supply on-off valve 45, the high-temperature water supply on-off valve 48, the water extraction on-off valve 50, the oxygen gas on-off valve 64B, the hydrogen gas on-off valve 68B, the start-up fuel gas on-off valve 72B, the mixing fuel gas on-off valve 77B, the boiler steam on-off valve 82B, the gasification agent steam on-off valve 87B, the first off-gas on-off valve 117, the steam on-off valve 221A, the biomass on-off valve 223A, the second off-gas on-off valve 227, the oxygen gas on-off valve 235A, the biomass gas on-off valve 280A, and the bio-liquid fuel on-off valve 291B.

The various types of equipment constituting the plant 1 include a damper. When the controller 90 transmits a signal (control signal) to the damper, the damper is switched between an open state and a closed state. Here, the damper includes the exhaust damper 31 and the water recovery damper 59.

Further, the equipment constituting the plant 1 includes various types of pumps such as the water supply pump 18, the water recovery pump 38, and the cooling water supply pump 55, various types of devices and various types of facilities constituting the bio-liquid fuel production plant 200, and various types of devices and various types of facilities constituting the fuel refining plant 100. The various types of pumps, the various types of devices, and the various types of facilities are controlled by the controller 90.

### 7. Start-Up Method of Plant 1

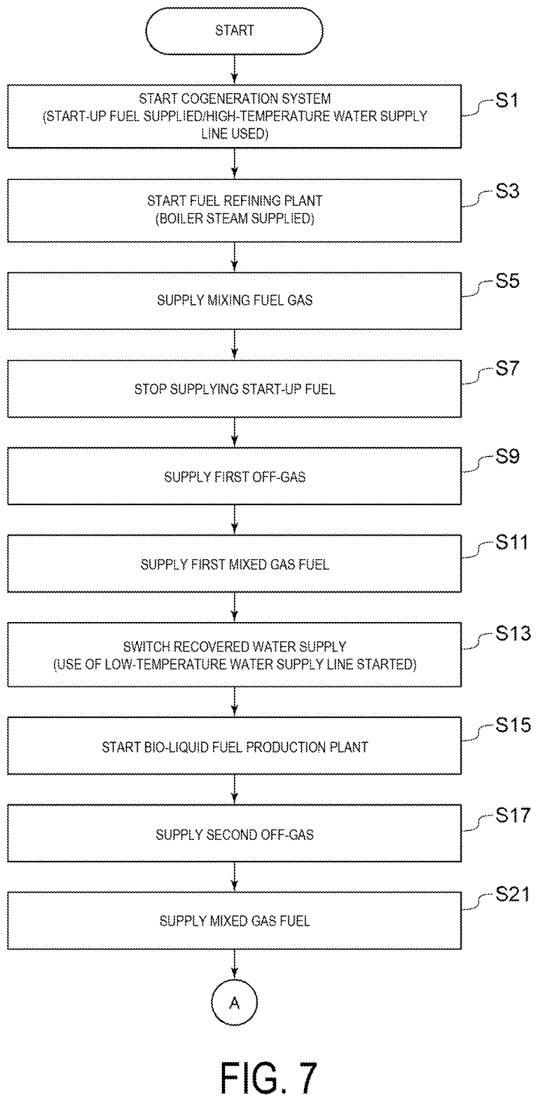

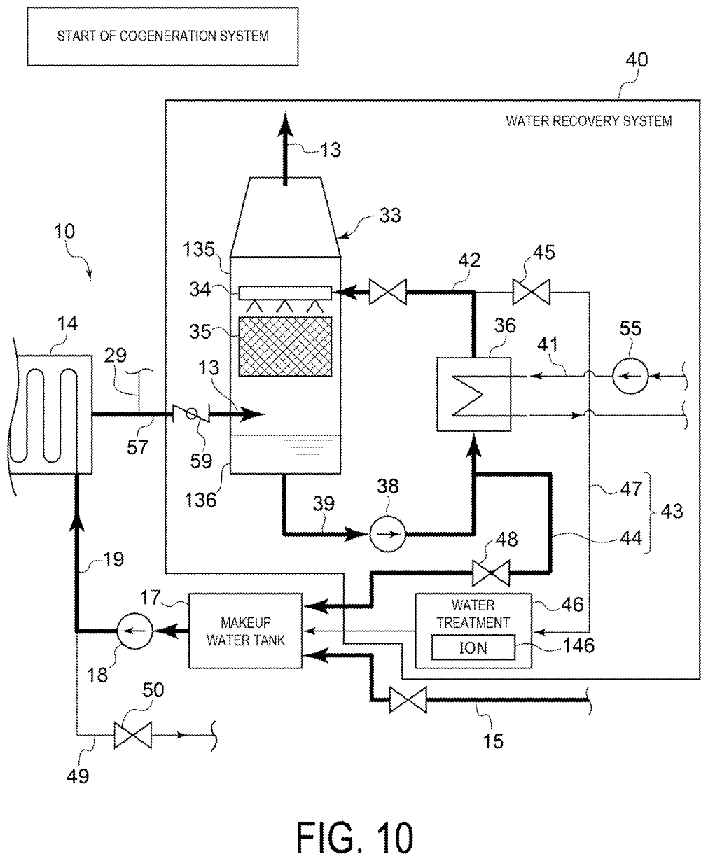

A start-up method of the plant 1 according to a first embodiment and a start-up method of the plant 1 according to a second embodiment will be described in this order with reference to FIGS. 7 to 17. The start-up method of the plant 1 is executed by the controller 90 transmitting a signal (control) to the various types of equipment constituting the plant 1. Hereinafter, the start-up method will be described while descriptions related to transmission and reception of signals performed between the controller 90 and the various types of equipment. In the following description, “step” may be abbreviated as “S”. The start-up method of the plant 1 includes a start-up method of the gas turbine cogeneration system 10. Before the start-up of the plant 1, all of the on-off valves and the dampers constituting the plant 1 are closed.

### 7-1. Start-Up Method According to First Embodiment

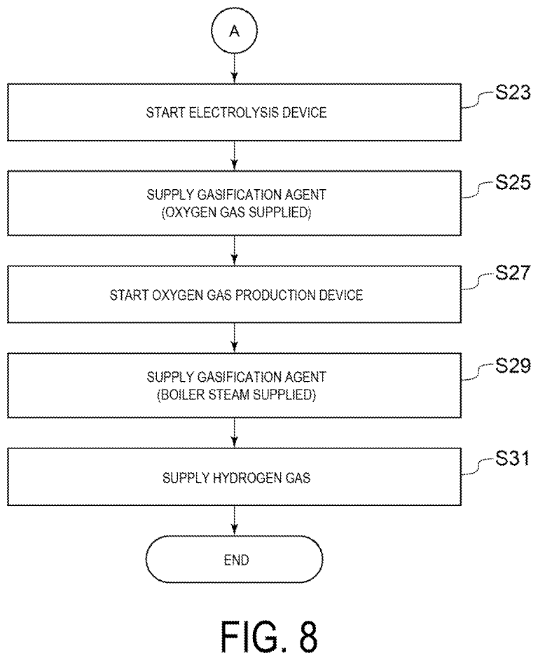

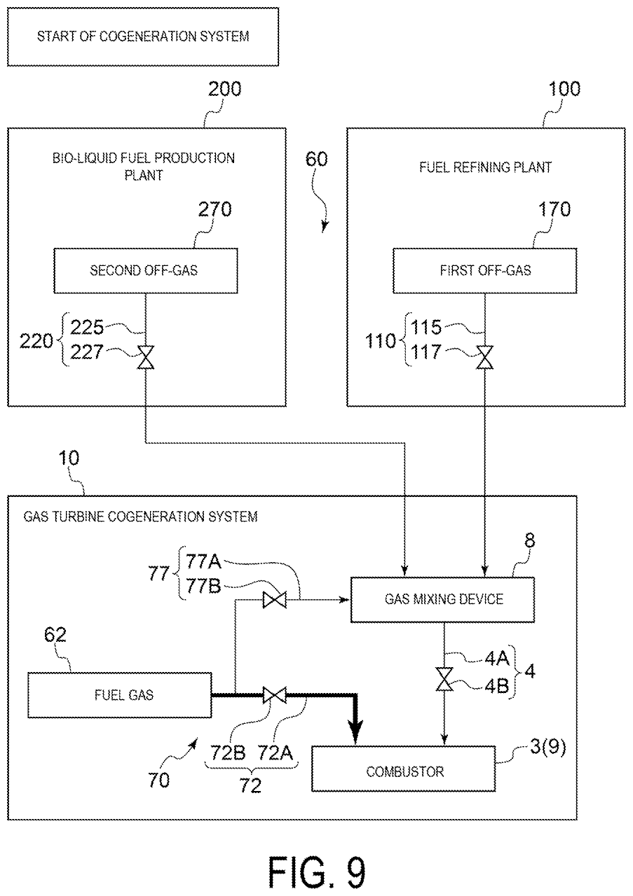

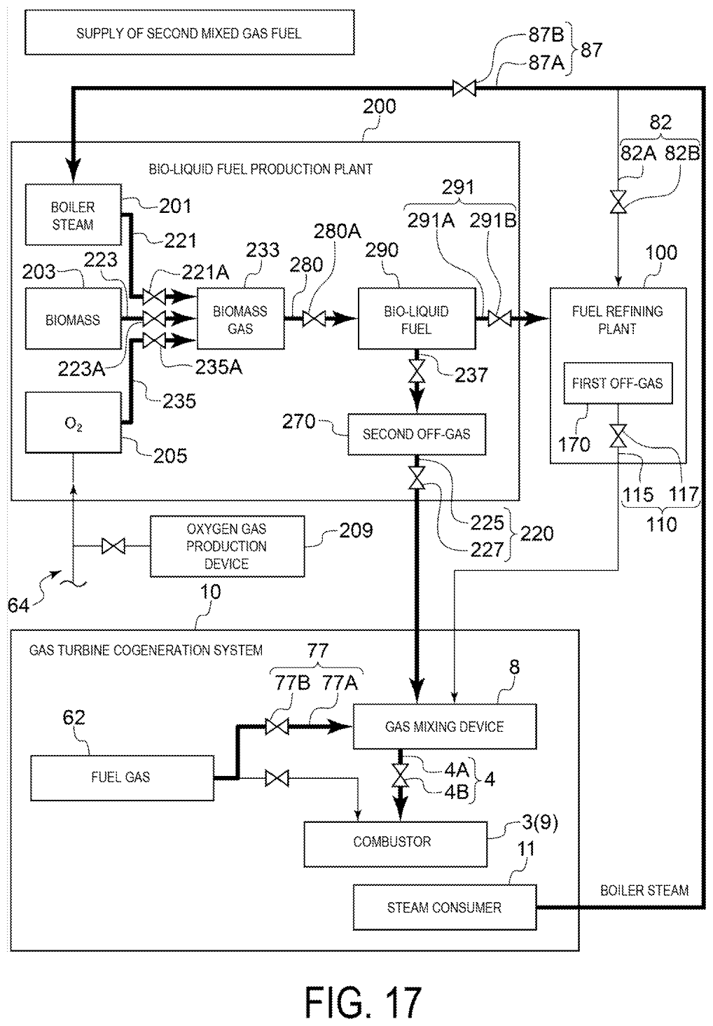

FIG. 7 is a flowchart illustrating the start-up method of the plant 1 according to the first embodiment. FIG. 8 is a flowchart illustrating a continuation of the start-up method of the plant 1. FIGS. 9 to 15 are schematic diagrams illustrating a process of the start-up method of the plant 1, and thick lines in each drawing indicate that a supply target or a discharge target flows (the same applies to FIG. 17). Here, the supply target or the discharge target is a gas such as the exhaust gas 13, a boiler steam, a fuel gas, a hydrogen gas, or an oxygen gas, a liquid such as a bio-liquid fuel, a crude oil, or a boiler feedwater, or a solid such as biomass.

First, as illustrated in FIGS. 7, 9, and 10, a cogeneration system start-up step (S1) of starting the cogeneration system 10 is executed. In S1, the rotational driving of the gas turbine 9 is started by a starting device (not illustrated), and the start-up fuel gas on-off valve 72B is opened so that the start-up fuel gas supply line 72 exclusively supply a fuel gas as a start-up fuel to the combustor 3. Single fuel combustion is caused in a combustion chamber of the combustor 3. Further, in S1, the water recovery damper 59 is opened, and the water recovery pump 38 and the cooling water supply pump 55 are driven, thereby starting the water recovery system 40. The water recovery device 33 starts recovering moisture from the exhaust gas 13. Furthermore, the high-temperature water supply on-off valve 48 of the water recovery system 40 is opened, and the supply of a recovered water having a high temperature from the high-temperature water supply line 44 to the makeup water tank 17 is started. At this time, the supply of a makeup water from the water supply line 15 to the makeup water tank 17 is also started. In addition, the water supply pump 18 is driven to cause the water supply line 19 to supply a boiler feedwater to the waste heat recovery boiler 14.

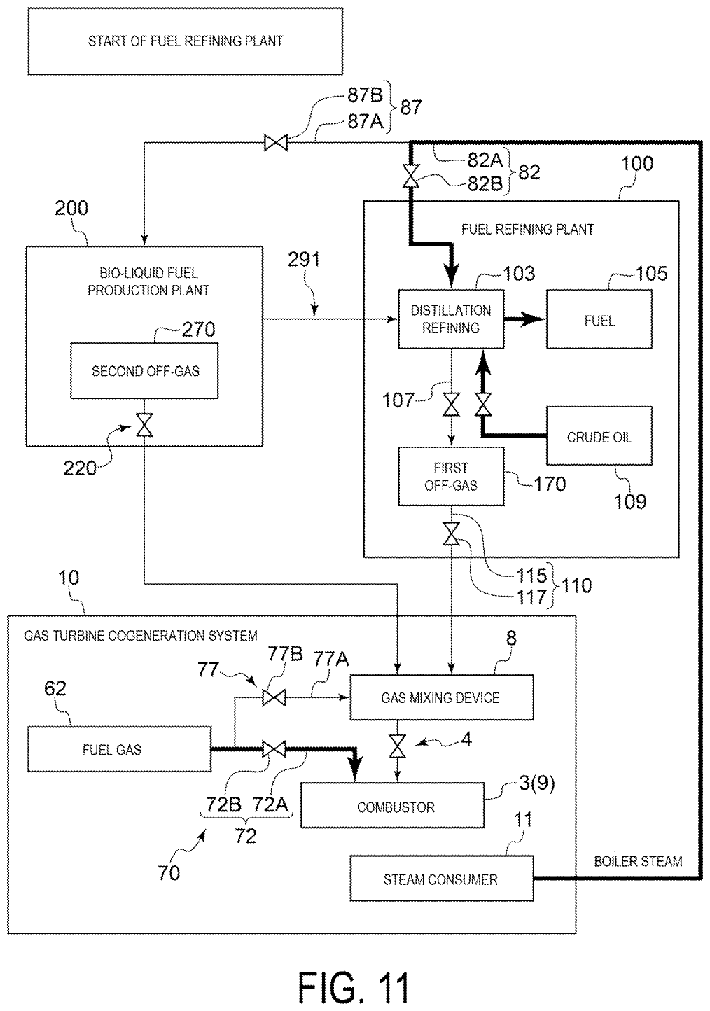

Next, as illustrated in FIGS. 7 and 11, a fuel refining plant start-up step (S3) is executed. In S3, a crude oil is supplied from the crude oil supply facility 109 to the distillation refining device 103, and the distillation refining device 103 starts operating. At this time, the boiler steam on-off valve 82B is opened, and the boiler steam supply line 82 starts supplying a boiler steam to the distillation refining device 103. The distillation refining device 103 refines the crude oil, which is an example of oil, into a fuel using the boiler steam as a heat source.

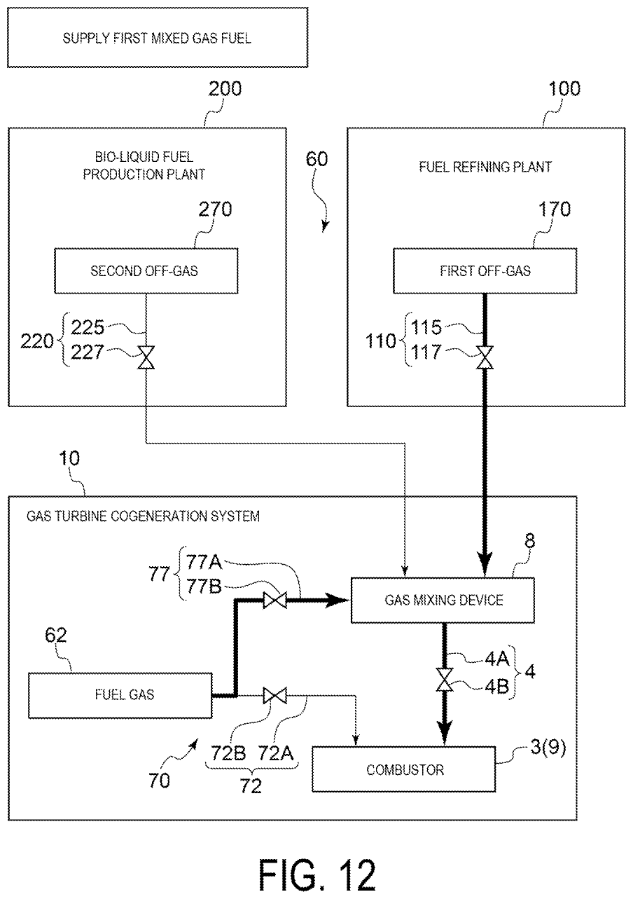

Next, as illustrated in FIGS. 7 and 12, the mixing fuel gas on-off valve 77B is opened, thereby executing a mixing fuel gas supply step (S5) in which the mixing fuel gas supply line 77 supplies the fuel gas to the gas mixing device 8. When S5 is executed, the mixed gas fuel on-off valve 4B is also opened, and the fuel gas is supplied from the gas mixing device 8 to the combustor 3.

Next, the start-up fuel gas on-off valve 72B is closed, thereby executing a start-up fuel supply stop step (S7) in which the start-up fuel gas supply line 72 stops supplying the fuel gas to the combustor 3.

Then, the first off-gas on-off valve 117 is opened, thereby executing a first off-gas supply step (S9) in which the first off-gas supply line 110 supplies the first off-gas to the gas mixing device 8. As a result, the gas mixing device 8 produces the first mixed gas fuel by mixing the fuel gas and the first off-gas. The first mixed gas fuel is supplied to the combustor 3 via the mixed gas fuel supply line 4 (S11), and multi-fuel combustion of the fuel gas and the first off-gas is caused in the combustion chamber. The first mixed gas fuel does not contain the second off-gas.

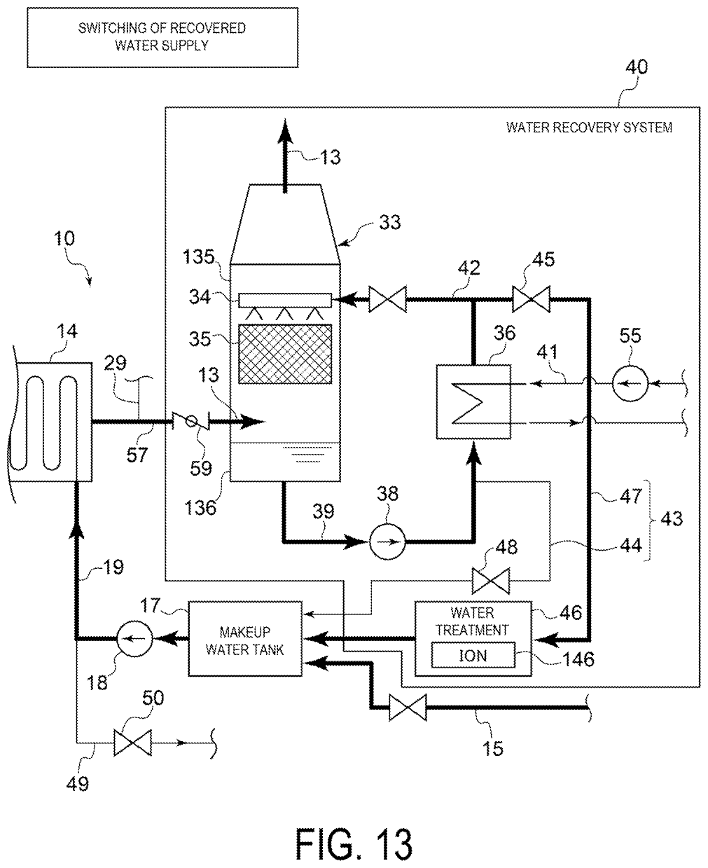

Next, as illustrated in FIGS. 7 and 13, a recovered water supply switching step (S13) is executed. In S13, the high-temperature water supply on-off valve 48 is closed, and the supply of the recovered water having a high temperature by the high-temperature water supply line 44 is stopped. At the same time, the low-temperature water supply on-off valve 45 is opened, and the supply of the recovered water having a low temperature by the low-temperature water supply line 47 is started. The recovered water having a low temperature is supplied to the makeup water tank 17 through the water treatment device 46.

Thus, even when impurities are contained in the recovered water due to combustion of the first mixed gas fuel containing the first off-gas, the recovered water from which the impurities have been removed can be supplied to the makeup water tank 17. S13 may be executed before S11. In that case, S13 is preferably executed after S7 and before S11.

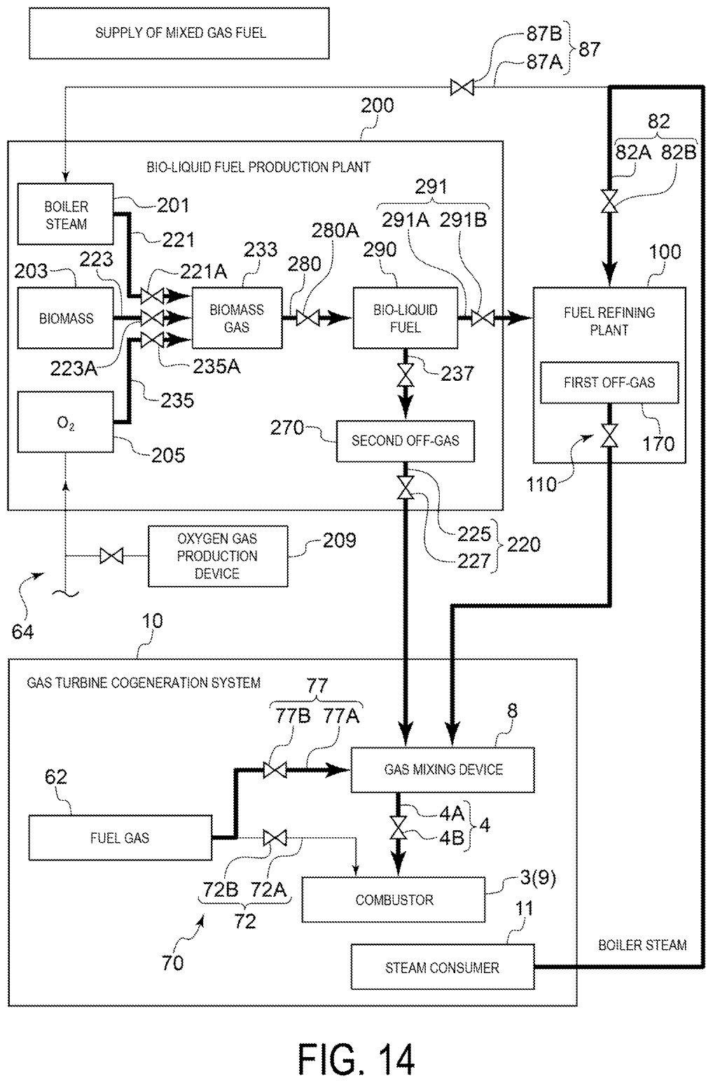

Next, as illustrated in FIGS. 7 and 14, a bio-liquid fuel production plant start-up step (S15) is executed. In S15, the steam on-off valve 221A, the biomass on-off valve 223A, and the oxygen gas on-off valve 235A are opened, and the steam supply device 201, the biomass supply device 203, the oxygen gas supply device 205, and the gasification device 233 are started. At the same time, the biomass gas on-off valve 280A and the bio-liquid fuel on-off valve 291B are opened, and the bio-liquid fuel production device 290 is started. As a result, the gasification device 233 produces a biomass gas and the bio-liquid fuel production device 290 produces a bio-liquid fuel. The bio-liquid fuel production device 290 supplies the bio-liquid fuel to the distillation refining device 103 of the fuel refining plant 100 through the bio-liquid fuel supply pipe 291A. At this time, the crude oil supply facility 109 may be stopped.

When S15 is executed, both of the gasification agent steam supply line 87 and the oxygen gas supply line 64 have not yet started operating. However, in a start-up phase of the bio-liquid fuel production plant 200, the amount of the biomass supplied to the gasification device 233 is small, and the amounts of the boiler steam and the oxygen gas required in the gasification device 233 are small. Therefore, the gasification device 233 and the bio-liquid fuel production plant 200 are started without any problem, and the bio-liquid fuel production device 290 generates the second off-gas together with the bio-liquid fuel.

Next, the second off-gas on-off valve 227 is opened, thereby executing a second off-gas supply step (S17) in which the second off-gas supply line 220 supplies the second off-gas to the gas mixing device 8. The gas mixing device 8 produces a mixed gas fuel containing the fuel gas, the first off-gas, and the second off-gas. As a result, a mixed gas fuel supply step (S21) in which the mixed gas fuel is supplied to the combustor 3 via the mixed gas fuel supply line 4 is executed. Then, multi-fuel combustion of the fuel gas, the first off-gas, and the second off-gas is caused in the combustion chamber of the combustor 3. At this time, the amount of the impurities in the exhaust gas 13 is equal to or larger than an allowable value and smaller than an allowable upper limit value, the low-temperature water supply line 47 continues to operate, and the high-temperature water supply line 44 does not operate.

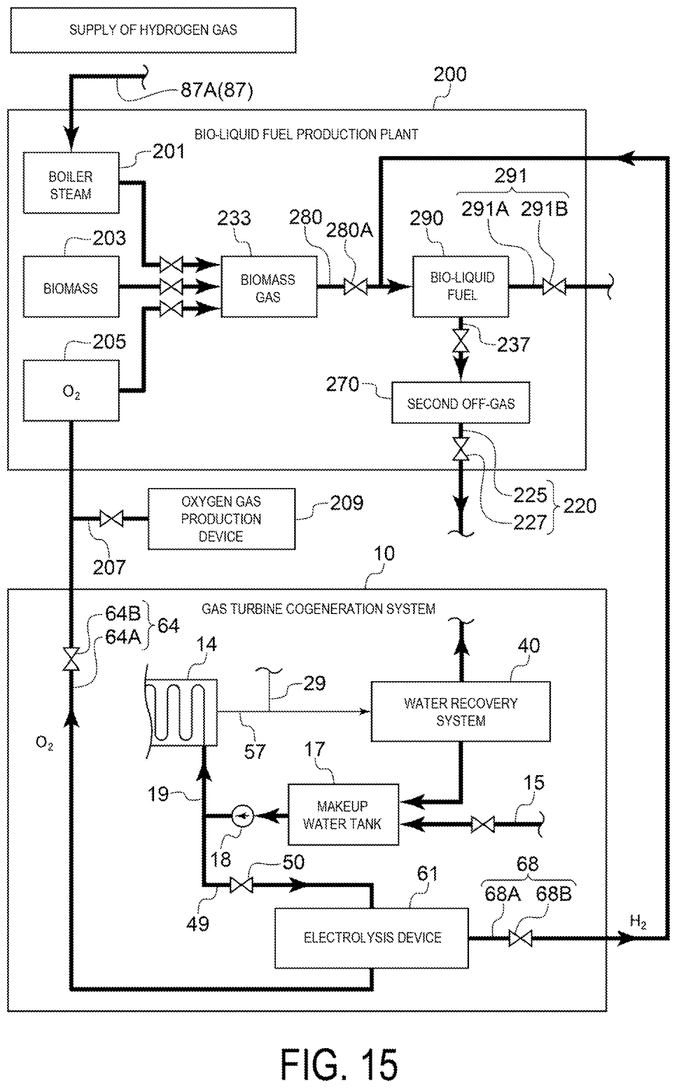

Next, as illustrated in FIGS. 8 and 15, an electrolysis device start-up step (S23) of starting the electrolysis device 61 is executed. In S23, the water extraction on-off valve 50 is opened to supply the industrial water to the electrolysis device 61, and the electrolysis device 61 is started. As a result, an oxygen gas and a hydrogen gas are generated in the electrolysis device 61.

Next, the oxygen gas on-off valve 64B is opened, thereby executing an oxygen gas supply step (S25) in which the oxygen gas supply line 64 starts supplying the oxygen gas to the oxygen gas supply device 205. Further, an oxygen gas production device start-up step (S27) of starting the oxygen gas production device 209 is executed. The oxygen gas produced by the oxygen gas production device 209 flows into the oxygen gas supply line 64 and is supplied to the oxygen gas supply device 205.

Next, the gasification agent steam on-off valve 87B (see FIG. 15) is opened, thereby executing a gasification agent supply step (S29) in which the gasification agent steam supply line 87 starts supplying the boiler steam as a gasification agent to the steam supply device 201. The gasification agent steam supply line 87 supplies the boiler steam as a gasification agent to the gasification device 233 via the steam supply device 201 and the steam supply tube 221.

Next, the hydrogen gas on-off valve 68B is opened, thereby executing a hydrogen gas supply step (S31) in which the hydrogen gas supply line 68 starts supplying the hydrogen gas. As a result, the amount of the hydrogen gas flowing into the bio-liquid fuel production device 290 increases, and the production amount of bio-liquid fuel increases.

Advantages achieved in the above-described start-up method of the plant 1 according to the first embodiment will be described.

Since the fuel refining plant start-up step (S3) is executed before the bio-liquid fuel production plant start-up step (S15), the fuel refining plant 100 can immediately receive the bio-liquid fuel produced by the bio-liquid fuel production device 290. Thus, the time from the production of the bio-liquid fuel to the refining of the fuel can be shortened. In the mixed gas fuel supply step (S21) executed after the bio-liquid fuel production plant start-up step (S15), the mixed gas fuel containing the fuel gas, the first off-gas, and the second off-gas can be supplied to the gas turbine 9, and thus the calorific value obtained by combustion in the combustor 3 can be secured, and the combustion gas 12 having a high temperature can be supplied to the turbine 2 to drive the gas turbine 9. Accordingly, the start-up method of the plant 1 including the cogeneration system 10 that uses the second off-gas obtained in the course of producing the bio-liquid fuel as a fuel is implemented. In addition, since the second off-gas is used as a fuel, it is possible to reduce the consumption amount of the fuel gas having a large calorific value per unit mass and to contribute to carbon neutrality.

In the start-up method described above, after the gas turbine 9 is started in the cogeneration system start-up step (S1) including a step of supplying the start-up fuel, the mixed gas fuel is supplied to the combustor 3 in the mixed gas fuel supply step (S21). As a result, the calorific value obtained by combustion in the combustor 3 can be secured, and thus the combustion gas 12 having a high temperature can be supplied to the turbine 2 to drive the gas turbine 9. Therefore, a fuel supply method for the cogeneration system 10 in which the second off-gas obtained in the course of producing the bio-liquid fuel from the biomass can be supplied to the cogeneration system 10 as a fuel is implemented.

In general, the amount of boiler steam required in the course of producing a biomass gas from biomass is large. In this regard, in the start-up method described above, after the execution of the cogeneration system start-up step (S1), the gasification agent supply step (S29) of starting the supply of the boiler steam as a gasification agent to the gasification device 233 is executed. According to the above-described configuration, the steam as a gasification agent required to produce the biomass gas can be secured by the boiler steam discharged from the waste heat recovery boiler 14. Since the amount of the boiler steam discharged from the waste heat recovery boiler 14 is very large, it is possible to avoid a shortage of the steam as a gasification agent in the gasification device 233 and to produce a sufficient amount of biomass gas.

In the start-up method described above, while the cogeneration system start-up step (S1) is executed, the recovered water is supplied to the makeup water tank 17 by the high-temperature water supply line 44. Therefore, the temperature of the boiler feedwater supplied to the waste heat recovery boiler 14 can be increased, and the operation efficiency of the cogeneration system 10 can be improved.

In the start-up method described above, the first mixed gas fuel is supplied to the combustor 3 of the gas turbine 9 in a first mixed gas fuel supply step (S11). As a result, the combustion environment in the combustor 3 such as a hydrogen gas concentration in the combustion chamber or a temperature in the combustion chamber can be adjusted to a combustion environment for supplying the mixed gas fuel containing the second off-gas to the gas turbine 9. On the other hand, the first mixed gas fuel containing the first off-gas contains a certain amount of impurities, and there is a concern that the amount of the impurities in the exhaust gas 13 becomes equal to or larger than an allowable value. In this regard, according to the above-described configuration, after the execution of the fuel refining plant start-up step (S3), the recovered water supply switching step (S13) is executed. Thus, the low-temperature water supply line 47 supplies the recovered water instead of the high-temperature water supply line 44, and the water treatment device 46 can remove the impurities contained in the recovered water in the course of the supply of the recovered water. As a result, it is possible to prevent the equipment constituting the cogeneration system 10 from being corroded due to the adhesion of the impurities to the equipment.

In the start-up method described above, since the electrolysis device start-up step (S23) and the oxygen gas supply step (S25) are performed in this order, the oxygen gas obtained by utilizing the recovered water recovered by the water recovery device 33 can be used as a gasification agent in the gasification device 233. Thus, a sufficient amount of the gasification agent can be supplied to the gasification device 233 by utilizing the moisture contained in the exhaust gas 13.

In the start-up method described above, since the electrolysis device start-up step (S23) and the hydrogen gas supply step (S31) are executed in this order, the hydrogen gas obtained by utilizing the recovered water recovered by the water recovery device 33 can be used to produce the bio-liquid fuel. Thus, a sufficient amount of the hydrogen gas can be supplied to the bio-liquid fuel by utilizing the moisture contained in the exhaust gas 13.

Further, in the start-up method described above, the oxygen gas production device start-up step (S27) is executed, whereby it is possible to avoid the shortage of the oxygen gas to be supplied to the gasification device 233.

In the start-up method described above, the mixing fuel gas supply step (S5) is executed before the execution of the first off-gas supply step (S9) and the second off-gas supply step (S17). In other words, the mixed gas fuel supply line 4 is configured to start supplying the fuel gas to the gas mixing device 8 before the first off-gas supply line 110 starts supplying the first off-gas and before the second off-gas supply line 220 starts supplying the second off-gas. According to the above-described configuration, a mixing chamber of the gas mixing device 8 can be filled with the fuel gas having a relatively high calorific value per unit mass. This makes it possible to prevent the calorific value per unit mass of the mixed gas fuel from falling below an allowable lower limit value.

In the start-up method described above, the first mixed gas fuel supply step (S11) is executed after the execution of the start-up fuel supply step (S1) and before the execution of the mixed gas fuel supply step (S21). In other words, the first off-gas supply line 110 is configured to start supplying the first off-gas before the second off-gas supply line 220 starts supplying the second off-gas. Further, the mixed gas fuel supply line 4 is configured to supply the first mixed gas fuel produced by the gas mixing device 8 to the combustor 3 before the second off-gas supply line 220 starts supplying the second off-gas. According to the above-described configuration, the combustion environment in the combustor 3 such as a hydrogen gas concentration in the combustion chamber or a temperature in the combustion chamber can be optimized for the combustion of the mixed gas fuel containing the fuel gas, the first off-gas, and the second off-gas.

### 7-2. Start-Up Method According to Second Embodiment

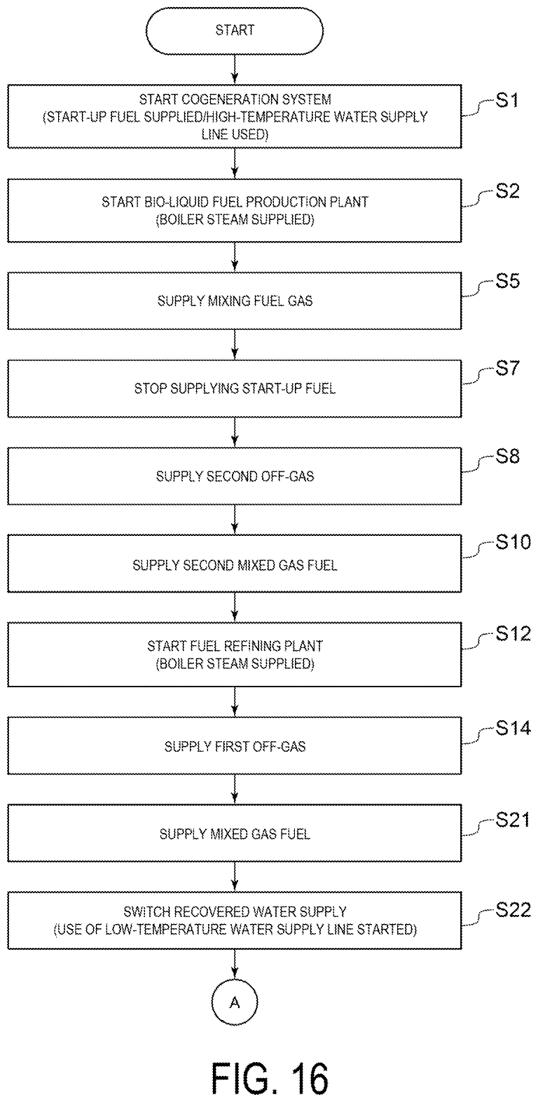

A start-up method of the plant 1 according to a second embodiment will be described with reference to FIGS. 9, 10, 16, and 17. FIG. 16 is a flowchart illustrating the start-up method of the plant 1 according to the second embodiment. In the second embodiment, S2, S8 to S14, and S22 are executed in substitution for S3, S9 to S17 illustrated in FIG. 7. Among the steps illustrated in FIG. 16, the same steps as in the first embodiment are given the same step numbers as those in FIG. 7. Further, in FIG. 16, steps after S23 of the start-up method of the plant 1 according to the second embodiment is identical to the steps indicated by S23 to S31 (see FIG. 8) of the method according to the first embodiment.

As illustrated in FIGS. 9, 10 and 16, a cogeneration system start-up step (S1) is first executed. The details of this step are as described in the start-up method according to the first embodiment, and the high-temperature water supply line 44 starts supplying a recovered water having a high temperature as in the first embodiment.

Next, as illustrated in FIGS. 16 and 17, a bio-liquid fuel production plant start-up step (S2) is executed. In S2, the gasification agent steam on-off valve 87B is opened, and the supply of a boiler steam as a gasification agent to the steam supply device 201 is started. At the same time, the steam supply device 201, the biomass supply device 203, the oxygen gas supply device 205, the gasification device 233, and the bio-liquid fuel production device 290 are started. The details are as described in S15 according to the first embodiment. At this time, although no oxygen gas is supplied from the oxygen gas supply line 64 to the oxygen gas supply device 205, the amount of biomass supplied to the gasification device 233 being started is small, and thus the start-up of the gasification device 233 and the bio-liquid fuel production plant 200 is executed without any problem.

Next, as in the first embodiment, a mixing fuel gas supply step (S5) and a start-up fuel supply stop step (S7) are executed in this order.

Next, the second off-gas on-off valve 227 is opened, thereby executing a second off-gas supply step (S8) in which the second off-gas supply line 220 supplies the second off-gas to the gas mixing device 8. As a result, the gas mixing device 8 produces a second mixed gas fuel by mixing the fuel gas and the second off-gas. The second mixed gas fuel is supplied to the combustor 3 via the mixed gas fuel supply line 4 (S10), and multi-fuel combustion of the fuel gas and the second off-gas is caused in the combustion chamber. The second mixed gas fuel does not contain the first off-gas.

Next, a fuel refining plant start-up step (S12) is executed. Specifically (see also FIG. 11), the distillation refining device 103 is started, the boiler steam on-off valve 82B is opened, and a boiler steam as a heat source is supplied to the distillation refining device 103. At this time, the distillation refining device 103 distills and refines the bio-liquid fuel supplied by the bio-liquid fuel supply line 291. When S12 is executed, the crude oil supply facility 109 is not necessarily operated.

Next, the first off-gas on-off valve 117 is opened, thereby executing a first off-gas supply step (S14) in which the first off-gas supply line 110 supplies the first off-gas to the gas mixing device 8. As a result, the gas mixing device 8 produces a mixed gas fuel containing the fuel gas, the first off-gas, and the second off-gas. Then, a mixed gas fuel supply step (S21) in which the mixed gas fuel is supplied to the combustor 3 via the mixed gas fuel supply line 4 is executed.

Next, a recovered water supply switching step (S22) is executed. In S22, similarly to S13 according to the first embodiment, the high-temperature water supply on-off valve 48 is closed, and the low-temperature water supply on-off valve 45 is opened. Thus, even when impurities are contained in the recovered water due to the combustion of the mixed gas fuel containing the first off-gas, the recovered water from which the impurities have been removed can be supplied to the makeup water tank 17. When the amount of the impurities in the exhaust gas 13 is smaller than an allowable value at the time of combustion of the mixed gas fuel, S22 is not necessarily executed.

After the execution of S22, steps S23 to S31 in FIG. 8 are executed, and the start-up method of the plant 1 according to the second embodiment is ended. In order to avoid redundant descriptions, detailed descriptions of S23 to S31 according to the second embodiment are omitted.

Advantages achieved in the above-described start-up method of the plant 1 according to the second embodiment will be described. However, descriptions of the same advantages as those achieved in the start-up method of the plant 1 according to the first embodiment will be omitted.

According to the configuration in which the bio-liquid fuel production plant start-up step (S2) is executed before the execution of the fuel refining plant 100 start-up step (S12), the boiler steam can be supplied early to the bio-liquid fuel production plant 200 that consumes a relatively large amount of steam, and thus the boiler steam discharged from the waste heat recovery boiler 14 started can be effectively utilized in an early stage. Further, in the mixed gas fuel supply step (S21), the mixed gas fuel containing the fuel gas, the first off-gas, and the second off-gas can be supplied to the gas turbine 9, and thus the calorific value obtained by combustion in the combustor 3 can be secured, and the combustion gas 12 having a high temperature can be supplied to the turbine 2 to drive the gas turbine 9. Accordingly, the start-up method of the plant 1 including the cogeneration system 10 that uses the second off-gas obtained in the course of producing the bio-liquid fuel as a fuel is implemented. In addition, since the second off-gas is used as a fuel, it is possible to reduce the consumption amount of the fuel gas having a large calorific value per unit mass and to contribute to carbon neutrality.

In the start-up method described above, the second mixed gas fuel supply step (S10) is executed after the bio-liquid fuel production plant start-up step (S2). According to the above-described configuration, the second mixed gas fuel is supplied to the combustor 3 of the gas turbine 9, whereby the combustion environment in the combustor 3 such as a hydrogen gas concentration in the combustion chamber or a temperature in the combustion chamber can be adjusted to a combustion environment for supplying the mixed gas fuel containing the first off-gas to the gas turbine 9.

In the start-up method described above, the second off-gas supply step (S8) is executed before the first off-gas supply step (S14), and the second mixed gas fuel supply step (S10) is executed after the start-up fuel supply step (S1) and before the mixed gas fuel supply step (S21). In other words, the second off-gas supply line 220 is configured to start supplying the second off-gas before the first off-gas supply line 110 starts supplying the first off-gas, and the mixed gas fuel supply line 4 is configured to supply the second mixed gas fuel produced by the gas mixing device 8 to the combustor 3 before the first off-gas supply line 110 starts supplying the first off-gas. According to the above-described configuration, the second mixed gas fuel containing the fuel gas and the second off-gas is supplied to the combustor 3. Thus, the combustion environment in the combustor 3 such as a hydrogen gas concentration in the combustion chamber or a temperature in the combustion chamber can be optimized for the mixed gas fuel containing the fuel gas, the first off-gas, and the second off-gas.

### 8. Modification Method of Plant 1

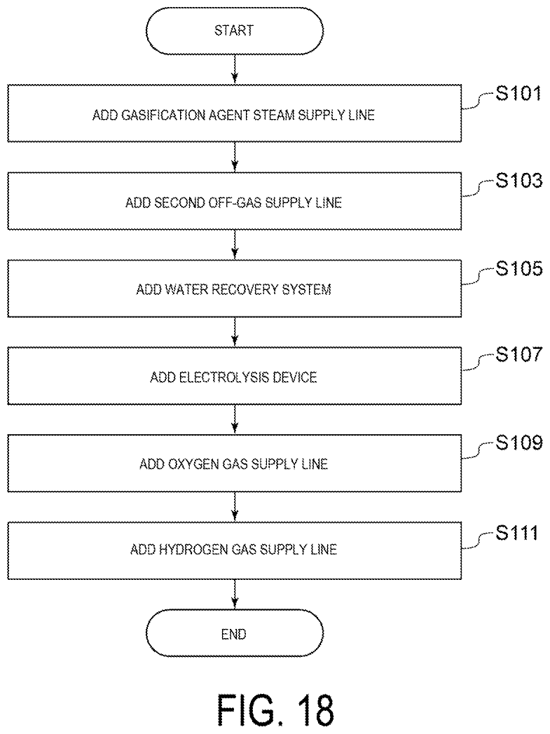

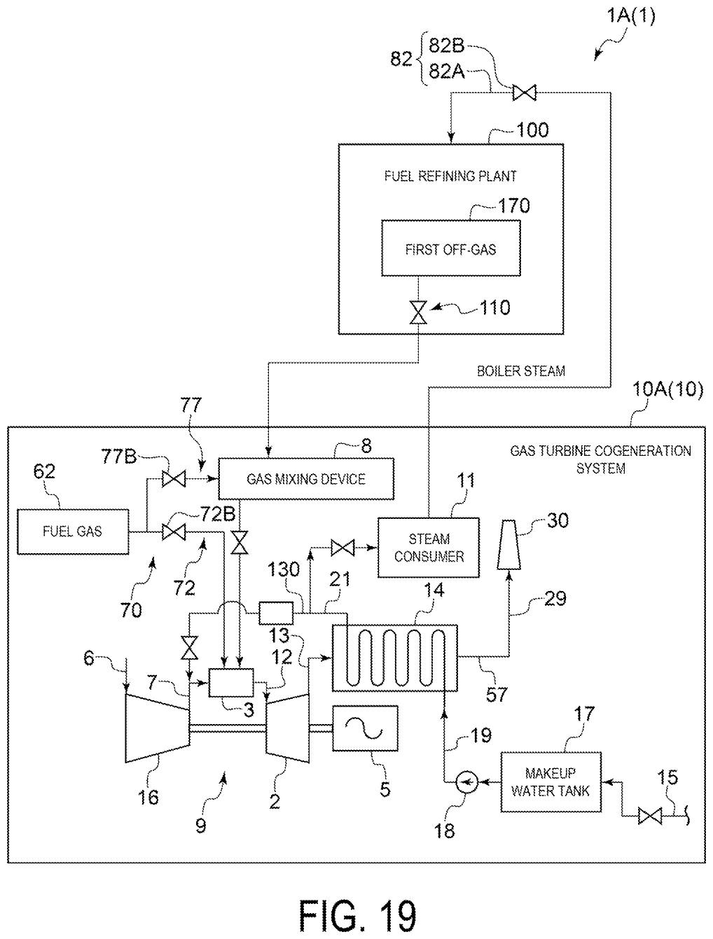

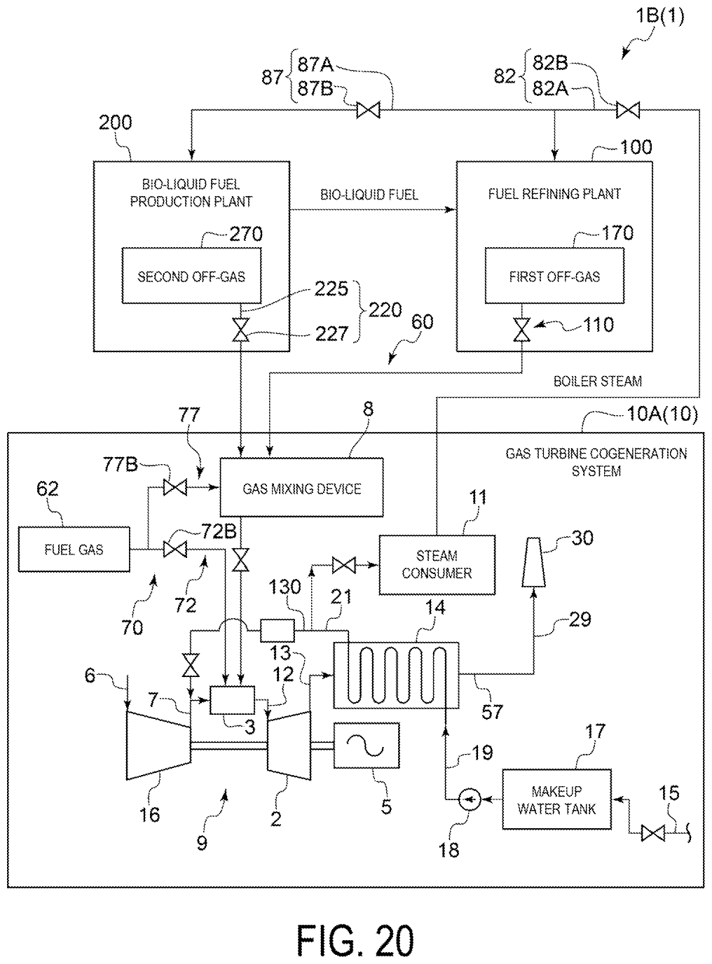

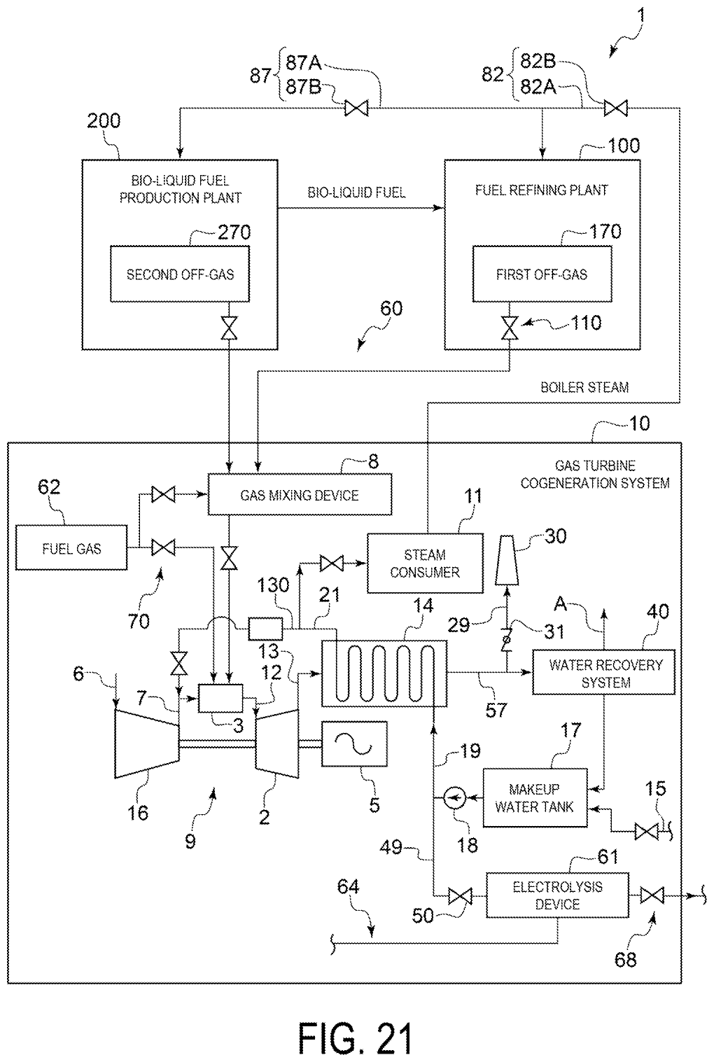

A method of modifying a plant 1A which is the plant 1 before modification will be described with reference to FIGS. 18 to 21. FIG. 18 is a flowchart illustrating a modification method of the plant 1A according to an embodiment of the disclosure. FIG. 19 is a schematic diagram of the plant 1A according to the embodiment of the disclosure. FIG. 20 is a schematic diagram of a plant 1B which is the plant 1 under the modification according to the embodiment of the disclosure. FIG. 21 is a schematic diagram of the plant 1 after the modification according to the embodiment of the disclosure.

The modification of the plant 1 is performed by an operator, a robot device operated by an operator, or a combination thereof. The modification method of the plant 1 described below includes a method of modifying the cogeneration system 10.

Prior to the description of the modification method, a plant 1A which is the plant 1 before the modification will be described with reference to FIG. 19. The plant 1A includes a cogeneration system 10A, which is the cogeneration system 10 before the modification, and the fuel refining plant 100. The plant 1A is provided with the boiler steam supply line 82. On the other hand, the plant 1A is not provided with the bio-liquid fuel production plant 200 and the gasification agent steam supply line 87. Further, the cogeneration system 10A is not provided with the water recovery system 40, the exhaust damper 31, the water extraction line 49, the water extraction on-off valve 50, the electrolysis device 61, the oxygen gas supply line 64, and the hydrogen gas supply line 68.

The modification method of the plant 1A will be described. As illustrated in FIGS. 18 to 20, first, a gasification agent steam supply line addition step (S101) of additionally providing the gasification agent steam supply line 87 and a second off-gas supply line addition step (S103) of additionally providing the second off-gas supply line 220 are executed in this order. When S101 and S103 are executed, a step of additionally providing the bio-liquid fuel production plant 200 at the plant 1A is also executed. In S101, the gasification agent steam supply pipe 87A is connected to the boiler steam supply pipe 82A and the steam supply device 201 (see FIG. 3), and the boiler steam on-off valve 82B is provided at the boiler steam supply pipe 82A. In S103, the second off-gas supply pipe 225 is connected to the second off-gas supply device 270 and the gas mixing device 8, and the second off-gas on-off valve 227 is provided at the second off-gas supply pipe 225. Accordingly, the plant 1A is modified into a plant 1B (see FIG. 20).

As illustrated in FIGS. 18, 20, and 21, a water recovery system addition step (S105) of additionally providing the water recovery system 40, an electrolysis device addition step (S107) of additionally providing the electrolysis device 61, an oxygen gas supply line addition step (S109) of additionally providing the oxygen gas supply line 64, and a hydrogen gas supply line addition step (S111) of additionally providing the hydrogen gas supply line 68 are executed in this order. In S105, an operation of additionally providing the exhaust damper 31 at the exhaust line 29 is also executed. In S107, an operation of additionally providing the water extraction line 49 and the water extraction on-off valve 50 is also executed. In S109, an operation of connecting the oxygen gas supply pipe 64A to the electrolysis device 61 and the oxygen gas supply device 205 (see FIG. 3) is executed, and an operation of connecting the oxygen gas production device 209 (see FIG. 3) and the oxygen gas supply pipe 64A with the oxygen gas discharge tube 207 (see FIG. 3) is executed. In S111, an operation of connecting the electrolysis device 61 and the biomass gas discharge tube 280 (see FIG. 6) with the hydrogen gas supply pipe 68A is executed.

Through the above-described steps, the plant 1 is completed (see FIG. 21). The advantages achieved by the plant 1 are as described above, and the method of modifying the cogeneration system 10 that is driven using the second off-gas obtained in the course of producing the bio-liquid fuel from the biomass as a fuel is implemented. In addition, since the second off-gas is used as a fuel, the method of modifying the cogeneration system 10 by which the consumption amount of the fuel gas having a large calorific value per unit mass can be reduced and which contributes to carbon neutrality is implemented.

The execution order of the above-described steps may be changed as appropriate. For example, S105 may be executed before S101 and S103. In addition, S107 to S111 may be executed before S105. Further, S105 to S111 are not necessarily executed. In that case, the plant 1B (see FIG. 20) is a modified plant. Also in the plant 1B, the second off-gas generated in the course of producing the bio-liquid fuel from biomass can be used as a fuel of the combustor 3 together with the fuel gas and the first off-gas. Accordingly, the calorific value obtained by combustion in the combustor 3 can be secured and the temperature of the combustion gas 12 to be supplied to the turbine 2 can be increased so that the gas turbine 9 can be driven. That is, the method of modifying the cogeneration system 10 is established as a method of modifying the cogeneration system 10 that is driven by using the second off-gas as a fuel without providing $105 to S111.

### 9. Summary

The contents of some embodiments described above can be understood as follows, for example.

1) A fuel supply system (60) according to at least one embodiment of the disclosure includes: a fuel gas supply line (70) configured to supply a fuel gas to a combustor (3) of a gas turbine (9); a first off-gas supply device (170) configured to supply a first off-gas generated in a fuel refining plant (100) to the combustor; a second off-gas supply device (270) configured to supply a second off-gas generated in a bio-liquid fuel production plant (200) to the combustor, the second off-gas having a calorific value per unit mass smaller than the fuel gas; a gas mixing device (8) configured to mix the fuel gas supplied by the fuel gas supply line, the first off-gas supplied by the first off-gas supply device, and the second off-gas supplied by the second off-gas supply device; and a mixed gas fuel supply line (4) configured to supply a mixed gas fuel produced by the gas mixing device to the combustor.

According to the configuration of 1) above, the mixed gas fuel supply line can supply the second off-gas generated in the bio-liquid fuel production plant as a fuel for the combustor together with the fuel gas and the first off-gas. As a result, the calorific value obtained by combustion in the combustor can be secured, and thus the combustion gas having a high temperature can be supplied to a turbine to drive the gas turbine. Thus, the fuel supply system to drive the gas turbine using the second off-gas obtained in the course of producing the bio-liquid fuel from biomass as a fuel is implemented.

2) Each of some embodiments is the fuel supply system described in 1) above, and the fuel gas supply line includes: a start-up fuel gas supply line (72) for supplying the fuel gas as a start-up fuel to the combustor; and a mixing fuel gas supply line (77) provided in parallel with the start-up fuel gas supply line and configured to supply the fuel gas to the gas mixing device.

According to the configuration of 2) above, the start-up fuel gas supply line and the mixed gas fuel supply line can use a fuel gas supply source in common, and thus the configuration of the fuel supply system can be simplified.

3) According to some embodiments, the fuel supply system described in 2) above further includes: a first off-gas supply line (110) for supplying the first off-gas from the first off-gas supply device to the gas mixing device; a second off-gas supply line (220) for supplying the second off-gas from the second off-gas supply device to the gas mixing device, wherein the mixing fuel gas supply line is configured to start supplying the fuel gas to the gas mixing device before the first off-gas supply line starts supplying the first off-gas and before the second off-gas supply line starts supplying the second off-gas.

According to the configuration of 3) above, a mixing chamber of the gas mixing device can be filled with the fuel gas first. This makes it possible to prevent the calorific value per unit mass of the mixed gas fuel from falling below an allowable lower limit value.

4) Each of some embodiments is the fuel supply system described in 3) above, and the first off-gas supply line is configured to start supplying the first off-gas before the second off-gas supply line starts supplying the second off-gas, and the mixed gas fuel supply line is configured to supply, to the combustor, a first mixed gas fuel containing the fuel gas and the first off-gas produced by the gas mixing device before the second off-gas supply line starts supplying the second off-gas.

According to the configuration of 4) above, the first mixed gas fuel containing the fuel gas and the first off-gas is supplied to the combustor. Thus, the combustion environment in the combustor such as a hydrogen gas concentration in a combustion chamber or a temperature in the combustion chamber can be optimized for the combustion of a mixed gas fuel containing the fuel gas, the first off-gas, and the second off-gas.

5) Each of some embodiments is the fuel supply system described in 3) above, and the second off-gas supply line is configured to start supplying the second off-gas before the first off-gas supply line starts supplying the first off-gas, and the mixed gas fuel supply line is configured to supply, to the combustor, a second mixed gas fuel containing the fuel gas and the second off-gas produced by the gas mixing device before the first off-gas supply line starts supplying the first off-gas.

According to the configuration of 5) above, the second mixed gas fuel containing the fuel gas and the second off-gas is supplied to the combustor. Thus, the combustion environment in the combustor such as a hydrogen gas concentration in the combustion chamber or a temperature in the combustion chamber can be optimized for the mixed gas fuel containing the fuel gas, the first off-gas, and the second off-gas.

6) A fuel supply method for a gas turbine cogeneration system according to at least one embodiment of the disclosure is a fuel supply method for a gas turbine cogeneration system for supplying a fuel to a gas turbine cogeneration system (10).

The gas turbine cogeneration system (10) includes:
a gas turbine (9) including a combustor (3); and
a waste heat recovery boiler (14) for producing steam using an exhaust gas discharged from the gas turbine as a heat source.

The method includes:
a start-up fuel supply step (S1) of supplying exclusively a fuel gas as a start-up fuel for the gas turbine; and
a mixed gas fuel supply step (S21) of supplying a mixed gas fuel to the combustor after execution of the start-up fuel supply step, the mixed gas fuel containing the fuel gas, a first off-gas generated in a fuel refining plant, and a second off-gas generated in a bio-liquid fuel production plant, the second off-gas having a calorific value per unit mass smaller than the fuel gas.

According to the configuration of 6) above, after the gas turbine is started by executing the start-up fuel supply step, the mixed gas fuel is supplied to the combustor by executing the mixed gas fuel supply step. As a result, the calorific value obtained by combustion in the combustor can be secured, and thus the combustion gas having a high temperature can be supplied to a turbine to drive the gas turbine. Therefore, the fuel supply method for a gas turbine cogeneration system in which the second off-gas obtained in the course of producing the bio-liquid fuel from biomass can be supplied to the gas turbine cogeneration system as a fuel is implemented.

7) Each of some embodiments is the fuel supply method for a gas turbine cogeneration system described in 6) above, and
the gas turbine cogeneration system further includes a gas mixing device (8) for mixing the fuel gas, the first off-gas, and the second off-gas, and
the fuel supply method for a gas turbine cogeneration system further includes:
   a first off-gas supply step (S9, S14) of supplying the first off-gas to the gas mixing device;
   a second off-gas supply step (S8, S17) of supplying the second off-gas to the gas mixing device; and
   a mixing fuel gas supply step (S5) of supplying the fuel gas to the gas mixing device before execution of the first off-gas supply step and before execution of the second off-gas supply step.

According to the configuration of 7) above, effects similar to those described in 3) above are achieved.

8) Each of some embodiments is the fuel supply method for a gas turbine cogeneration system described in 7) above, and
the gas mixing device is configured to produce a first mixed gas fuel containing the fuel gas and the first off-gas,
the first off-gas supply step is executed before execution of the second off-gas supply step,
a first mixed gas fuel supply step (S11) is further included in which the first mixed gas fuel produced by the gas mixing device is supplied to the combustor after execution of the start-up fuel supply step and before execution of the mixed gas fuel supply step.

According to the configuration of (8) above, effects similar to those described in 4) are achieved.

9) Each of some embodiments is the fuel supply method for a gas turbine cogeneration system described in 7) above, and
the gas mixing device is configured to produce a second mixed gas fuel containing the fuel gas and the second off-gas,
the second off-gas supply step is executed before execution of the first off-gas supply step, and
a second mixed gas fuel supply step (S10) is further included in which the second mixed gas fuel produced by the gas mixing device is supplied to the combustor after execution of the start-up fuel supply step and before execution of the mixing fuel gas supply step.

According to the configuration of 9) above, effects similar to those described in 5) are achieved.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A fuel supply system comprising:
a fuel gas supply line configured to supply a fuel gas to a combustor of a gas turbine;
a first off-gas supply device configured to supply a first off-gas generated in a fuel refining plant to the combustor;
a second off-gas supply device configured to supply a second off-gas generated in a bio-liquid fuel production plant to the combustor, the second off-gas having a calorific value per unit mass smaller than the fuel gas;
a gas mixing device configured to mix the fuel gas supplied by the fuel gas supply line, the first off-gas supplied by the first off-gas supply device, and the second off-gas supplied by the second off-gas supply device; and
a mixed gas fuel supply line configured to supply a mixed gas fuel produced by the gas mixing device to the combustor.

2. The fuel supply system according to claim 1, wherein
the fuel gas supply line includes
a start-up fuel gas supply line configured to supply the fuel gas as a start-up fuel to the combustor, and
a mixing fuel gas supply line provided in parallel with the start-up fuel gas supply line and configured to supply the fuel gas to the gas mixing device.

3. The fuel supply system according to claim 2, further comprising
a first off-gas supply line configured to supply the first off-gas from the first off-gas supply device to the gas mixing device, and
a second off-gas supply line configured to supply the second off-gas from the second off-gas supply device to the gas mixing device,
wherein the mixing fuel gas supply line is configured to start supplying the fuel gas to the gas mixing device before the first off-gas supply line starts supplying the first off-gas and before the second off-gas supply line starts supplying the second off-gas.

4. The fuel supply system according to claim 3, wherein
the first off-gas supply line is configured to start supplying the first off-gas before the second off-gas supply line starts supplying the second off-gas, and
the mixed gas fuel supply line is configured to supply a first mixed gas fuel to the combustor before the second off-gas supply line starts supplying the second off-gas, the first mixed gas fuel being produced by the gas mixing device and containing the fuel gas and the first off-gas.

5. The fuel supply system according to claim 3, wherein
the second off-gas supply line is configured to start supplying the second off-gas before the first off-gas supply line starts supplying the first off-gas, and
the mixed gas fuel supply line is configured to supply a second mixed gas fuel to the combustor before the first off-gas supply line starts supplying the first off-gas, the second mixed gas fuel being produced by the gas mixing device and containing the fuel gas and the second off-gas.

6. A fuel supply method for a gas turbine cogeneration system for supplying a fuel to a gas turbine cogeneration system,
the gas turbine cogeneration system comprising:
a gas turbine including a combustor; and
a waste heat recovery boiler configured to produce steam using an exhaust gas discharged from the gas turbine as a heat source,
the method comprising:
a start-up fuel supply step of supplying exclusively a fuel gas as a start-up fuel for the gas turbine; and
a mixed gas fuel supply step of supplying a mixed gas fuel to the combustor after execution of the start-up fuel supply step, the mixed gas fuel containing the fuel gas, a first off-gas generated in a fuel refining plant, and a second off-gas generated in a bio-liquid fuel production plant, the second off-gas having a calorific value per unit mass smaller than the fuel gas.

7. The fuel supply method for a gas turbine cogeneration system according to claim 6, wherein
the gas turbine cogeneration system further comprises a gas mixing device configured to mix the fuel gas, the first off-gas, and the second off-gas, and
the fuel supply method for a gas turbine cogeneration system further comprises
a first off-gas supply step of supplying the first off-gas to the gas mixing device,
a second off-gas supply step of supplying the second off-gas to the gas mixing device, and
a mixing fuel gas supply step of supplying the fuel gas to the gas mixing device before execution of the first off-gas supply step and before execution of the second off-gas supply step.

8. The fuel supply method for a gas turbine cogeneration system according to claim 7, wherein
the gas mixing device is configured to produce a first mixed gas fuel containing the fuel gas and the first off-gas,
the first off-gas supply step is executed before execution of the second off-gas supply step, and
a first mixed gas fuel supply step is further included in which the first mixed gas fuel produced by the gas mixing device is supplied to the combustor after execution of the start-up fuel supply step and before execution of the mixed gas fuel supply step.

9. The fuel supply method for a gas turbine cogeneration system according to claim 7, wherein
the gas mixing device is configured to produce a second mixed gas fuel containing the fuel gas and the second off-gas,
the second off-gas supply step is executed before execution of the first off-gas supply step, and
a second mixed gas fuel supply step is further included in which the second mixed gas fuel produced by the gas mixing device is supplied to the combustor after execution of the start-up fuel supply step and before execution of the mixing fuel gas supply step.
